(19) United States
(12) Patent Application Publication
(10) Pub. No.: US 2022/0204244 A1
(43) Pub. Date: Jun. 30, 2022

(54) BAG AND RELATED METHODS

(71) Applicant: Tecksom International Limited, Nassau (BS)

(72) Inventor: Luen Sing TANG, New Territories (HK)

(21) Appl. No.: 17/600,643

(22) PCT Filed: May 8, 2020
(86) PCT No.: PCT/IB2020/054360

§ 371 Date: Oct. 1, 2021

(30) Foreign Application Priority Data
May 10, 2019 (AU) 2019901600

(51) Int. Cl. B65D 81/34; B65D 75/30; B65D 81/32; B65D 75/58; B65D 75/00; B32B 27/32; B32B 27/34; B32B 27/36; B32B 27/08; B32B 1/00; B32B 27/30; B65B 5/10; B65B 5/02; B32B 7/12

(52) U.S. Cl. CPC B65D 81/3461; B32B 2307/31; B65D 81/3266; B65D 75/5805; B65D 75/008; B32B 27/32; B32B 27/34; B32B 27/36; B32B 27/08; B32B 1/00; B32B 27/306; B65B 5/10; B65B 5/022; B32B 7/12; B65D 2575/586; B32B 2439/46; B32B 2439/70; B65D 2581/3432; B65D 75/30

(57) ABSTRACT

A bag for containing one or more items to be heated in a microwave oven. The bag has a front panel and a back panel and has a seal across the containment region to split it into two compartments each containing at least one item such as a food ingredient. When the bag is heated, the compartments expand due to gas expansion and the seal is caused to break to allow the items to mix and be heated together.

### FIELD OF THE INVENTION

The present invention relates to bags for containing at least one item to be heated inside the bag. In particular but not solely, the present invention relates to bags for containing at least one food item to be heated inside the bag.

### BACKGROUND TO THE INVENTION

Bags, and particularly plastic bags are commonly used for holding, transporting, and storing products. Plastic bags are versatile and used widely in a vast array of applications including particularly for containing foods.

With busy lifestyles, there is a growing demand for convenience in preparing food that needs to be heated or cooked. Microwave bags or containers such as those containing corn or for making popcorn or instant noodles in, are well known. Such bags usually comprise of a single compartment and are not suitable for separating food ingredients that may require to be separated during storage and only need to be mixed at the time of the cooking.

Even if the ingredients are separated in separate compartment or packaging they usually require user to manually open the pre-packaged ingredients and mix the ingredients before heating or cooking the food item inside the microwave oven. This can be a time-consuming and messy exercise.

### OBJECT OF THE INVENTION

It is an object of the present invention to provide a bag and related methods which overcomes or at least partially ameliorates some of the abovementioned disadvantages, or which at least provides the public with a useful choice.

### SUMMARY OF THE INVENTION

In a first aspect, the invention resides in a bag for containing at least one item to be heated inside the bag in a microwave oven, the bag comprising:

a first primary panel and a second primary panel, the second primary panel being peripherally formed with and/or heat sealed to the first primary panel to form a containment region within the periphery, the containment region being split into at least two compartments by at least one seal extending across the containment region, the at least two compartments being a lower compartment located proximal to a base of the bag and an upper compartment located above or configured to be located above the lower compartment, the at least two compartments are each being configured to contain the at least one item, wherein, before heating of the at least one item, the at least one seal being configured to be in a closed configuration thereby separating the at least one item in the upper compartment from the at least one item in the lower compartment, and wherein, during heating of the at least one item, the at least one seal being configured to be in an open configuration so that the at least one item in the upper compartment is adapted to drop into the lower compartment due to gravity and mix with the at least one item in the lower compartment.

In one embodiment, the at least one seal extends horizontally across a lateral axis that is orthogonal to a vertical axis extending from a top portion to a bottom portion of the bag.

In one embodiment, the at least one item is a food item.

In one embodiment, the upper compartment is configured to contain a liquid item.

In one embodiment, the at least two compartments are each being configured to contain different items.

In one embodiment, the at least two compartments are each being configured to contain different food items.

In one embodiment the first primary panel is a front panel and the second primary panel is a back panel.

In one embodiment, each of the first and second primary panels are made up of a film comprising at least one of the following materials:
a. PET
b. Nylon
c. RCPP.

In one embodiment, each of the first and second primary layers is made up of a film comprising three layers, the three layers being a first layer of the film, a second layer of the film and a third layer of the film, the first layer of the film comprising RCPP, the second layer of the film comprising Nylon and the third layer of the film comprising PET, wherein the three layers (preferably bonded together (preferably by an adhesive material).

In one embodiment, the first layer of the film is an internal layer facing the containment region, the second layer of the film is an intermediate layer between the first layer of the film and the third layer of the film, and the third layer of the film is an external layer.

In one embodiment, the base of the bag is of a gusset formation (lower gusset formation) that is configured to spread open thereby providing footing for stability of the bag when the bag is in a standing position.

In one embodiment, pressure in the containment region causes the bag to be in the standing position.

In one embodiment, the at least one seal is a breakable polymeric seal that is configured to be in the open configuration upon heating.

In one embodiment, the at least one seal is an openable and re-closable sealing assembly.

In one embodiment, the at least one seal is a breakable polymeric seal that is configured to be in the open configuration upon heating and an openable and re-closable sealing assembly.

In one embodiment, the openable and re-closable sealing assembly is located between the lower compartment and the breakable polymeric seal.

In one embodiment, the breakable polymeric seal comprises EVA.

In one embodiment, the breakable polymeric seal comprises at least two layers, the two layers being a first layer of the breakable polymeric seal and a second layer of the breakable polymeric seal, the first layer of the breakable polymeric seal comprising EVA and the second layer of the breakable polymeric seal comprising CPP, wherein the first layer of the breakable polymeric seal and the second layer of the breakable polymeric seal are bonded together (preferably by an or the adhesive material).

In one embodiment, the breakable polymeric seal is configured to be bonded with a closure subassembly, the closure subassembly comprising two layers, the two layers being a first layer of the closure subassembly and a second layer of the closure subassembly, the first layer of the closure subassembly being OPP) or RCPP and the second layer of the closure subassembly being CPP.

In one embodiment, the first layer of the breakable polymeric seal is configured to be bonded with the first layer of the closure subassembly.

In one embodiment the breakable polymeric seal is bonded to or formed as a part of the first primary panel and the closure subassembly is bonded to or formed as the part of the second primary panel.

In one embodiment the breakable polymeric seal may be bonded to or formed as a part of the second primary panel and the closure subassembly is bonded to or formed as the part of the first primary panel.

In one embodiment, the openable and re-closable sealing assembly is a zip lock (lower zip lock).

In one embodiment, the zip lock (lower zip lock) is made out of PP or PE.

In one embodiment, the bag further comprises an opening at or near a top portion of the bag, which is opposite the base of the bag, the at least one item is configured to enter the upper compartment of the bag through the opening.

In one embodiment, the opening comprises an openable and re-closable assembly (upper openable and re-closable assembly) which when opened allows access to the upper compartment through the opening and which when closed prevents access to the upper compartment though the opening.

In one embodiment, the openable and re-closeable assembly (upper openable and re-closable assembly) is a zip lock (upper zip lock).

In one embodiment, the zip lock (upper zip lock) is made out of PP or PE.

In one embodiment, the bag further comprises a non-heat sealable assembly comprising a first non-heat sealable layer and a second non-heat sealable layer, the first and second non-heat sealable layers extending across the bag between two opposite sides of the bag and facing each other, the non-heat sealable assembly being located above the openable and re-closable assembly.

In one embodiment, at least of the first or second non-heat sealable layer comprises at least one of the following materials:
a. PE
b. PP
c. PET
d. CPP.

In one embodiment, the first non-heat sealable layer is made up of a film that comprises two layers, the two layers being a first layer of the film of the first non-heat sealable layer and a second layer of the film of the first non-heat sealable layer, the first layer of the film of the first non-heat sealable layer comprising PET and the second layer of the film of the first non-heat sealable layer comprising CPP, wherein the two layers of the film of the first non-heat sealable layer are bonded together by an or the adhesive material.

In one embodiment, the second non-heat sealable layer is made up of a film that comprises two layers, the two layers being a first layer of the second non-heat sealable layer and a second layer of the second non-heat sealable layer, the first layer of the second non-heat sealable layer comprising PE or PP and the second layer of the second non-heat sealable layer that comprising CPP, wherein the two layers of the second non-heat sealable layer that are bonded together (preferably by an or the adhesive material).

In one embodiment, the bag further comprises a line of weakness to facilitate tearing, the line of weakness extending across the bag between two opposite sides of the bag.

In one embodiment, a tear notch is provided at one or each of the opposite sides of the bag at where the bag can be torn by a user.

In one embodiment, the line of weakness is provided along or adjacent the at least one seal.

In one embodiment, the line of weakness is provided along or adjacent a or the breakable polymeric seal.

In one embodiment, the bag further comprises a vent opening that is provided at one or each opposite sides of the bag at an upper zone (upper compartment) where the upper compartment is located, the vent opening being configured to open during heating of the at least one item to allow gas and/or steam to escape the containment region.

In one embodiment, the upper zone (upper compartment) comprises a gusset formation (upper gusset formation) that is configured to spread open due to pressure in the containment region.

In one embodiment, the upper zone (upper compartment) comprises a vent layer (vent tape) extending across the bag along a fold line of the gusset formation (upper gusset formation, the vent layer (vent tape) being configured to provide the vent openings.

In one embodiment, the vent layer (vent tape) comprises EVA.

In one embodiment, the vent layer (vent tape) comprises at least two layers, the two layers being a first layer of the vent layer (vent tape) and a second layer of the vent layer (vent tape), the first layer of the vent layer (vent tape) comprising EVA and the second layer of the vent layer (vent tape) comprising PET, wherein the two layers of the vent layer (vent tape) are bonded together (preferably by an or the adhesive material).

In one embodiment, the line of weakness functions as a hinge line so that when the first and second primary panels are close to each other, the hinge line allows drooping, and when the first and second primary panels move apart, the hinge line allows the upper compartment to be above the lower compartment.

In a second aspect, the invention resides a bag for heating or cooking by heating at least one food item in a microwave oven, the bag comprising:

a first primary panel and a second primary panel peripherally formed with and/or sealed to the first primary panel to form a containment region within the periphery the bag being split into at least two zones by a seal extending across the containment region to create a lower zone at a base of the bag and an upper zone located or configured to be located above the lower zone, wherein the seal is an openable seal which is configured to open when the containment region is heated thereby allowing the at least one food item in containment region of the upper zone to pass through the seal and mix with the at least one food item in the containment region of the lower zone.

In one embodiment, the at least one seal extends horizontally across a lateral axis that is orthogonal to a vertical axis extending from a top portion to a bottom portion of the bag.

In one embodiment, the upper zone comprises an upper compartment and the lower zone comprises a lower compartment, the upper and lower compartments being configured to store the at least one food item.

In one embodiment, the upper and lower compartments are each being configured to contain different food items.

In one embodiment, the first primary panel is a front panel and the second primary panel is a back panel.

In one embodiment, the upper zone comprises an upper compartment and the lower zone comprises a lower compartment.

In one embodiment, each of the first and second primary panels are made up of a film comprising at least one of the following materials:
a. PET
b. Nylon
c. RCPP.

In one embodiment, each of the first and second primary panels are made up of a film comprising three layers, the three layers being a first layer of the film, a second layer of the film and a third layer of the film, the first layer of the film comprising RCPP, the second layer of the film comprising Nylon and the third layer of the film comprising PET, wherein the three layers are bonded together (preferably by an or the adhesive material).

In one embodiment, the first layer of the film is an internal layer facing the containment region, the second layer of the film is an intermediate layer between the first layer of the film and the third layer of the film, and the third layer is an external layer.

In one embodiment, the base of the bag is of a gusset formation (lower gusset formation) that is configured to spread open thereby providing footing for stability of the bag when the bag is in a standing position.

In one embodiment, pressure in the containment region causes the bag to be in the standing position.

In one embodiment, the seal is a breakable polymeric seal that is configured to be in the open configuration upon heating.

In one embodiment, the seal is provided by adhesion of the first and second primary panels together.

In one embodiment, the seal is an openable and re-closable sealing assembly.

In one embodiment, the seal is a breakable polymeric seal that is configured to be in the open configuration upon heating and an openable and re-closable sealing assembly.

In one embodiment, the openable and re-closable sealing assembly is located between the lower compartment and the breakable polymeric seal (preferably extending horizontally across a lateral axis that is orthogonal to a vertical axis extending from top portion to bottom portion of the bag and/or parallel to the breakable polymeric seal).

In one embodiment, the breakable polymeric seal comprises EVA.

In one embodiment, the breakable polymeric seal comprises at least two layers, the two layers being a first layer of the breakable polymeric seal and a second layer of the breakable polymeric seal, the first layer of the breakable polymeric seal comprising EVA and the second layer of the breakable polymeric seal comprising CPP, wherein the two layers of the breakable polymeric seal are bonded together (preferably by an or the adhesive material).

In one embodiment, the breakable polymeric seal is configured to be bonded with a closure subassembly, the closure subassembly comprising two layers, the two layers being a first layer of the closure subassembly and a second layer of the closure subassembly, the first layer of the closure subassembly being OPP or RCPP and the second layer of the closure subassembly being CPP.

In one embodiment, the first layer of the breakable polymeric seal is configured to be bonded with the first layer of the closure subassembly.

In one embodiment the breakable polymeric seal is bonded to or formed as a part of the first primary panel and the closure subassembly is bonded to or formed as the part of the second primary panel.

In one embodiment the breakable polymeric seal is bonded to or formed as a part of the second primary panel and the closure subassembly is bonded to or formed as the part of the first primary panel.

In one embodiment, the openable and re-closable sealing assembly is a zip lock (lower zip lock).

In one embodiment, the zip lock (lower zip lock) is made out of PP or PE. In one embodiment, the bag further comprises an opening at or near a top portion of the bag which is opposite the base of the bag, the at least one food item is configured to enter the upper zone of the bag through the opening.

In one embodiment, the opening comprises an openable and re-closable assembly (upper openable and re-closable assembly) which when opened allows access to the upper compartment through the opening and which when closed prevents access to the upper compartment though the opening.

In one embodiment, the openable and re-closeable assembly (upper openable and re-closable assembly) is a zip lock (upper zip lock).

In one embodiment, the zip lock (upper zip lock) is made out of a PP or PE.

In one embodiment, the bag further comprises a non-heat sealable assembly comprising a first non-heat sealable layer and a second non-heat sealable layer, the first and second non-heat sealable layers extending across (preferably extending horizontally across a lateral axis that is orthogonal to a vertical axis extending from top portion to bottom portion of the bag) the bag between two opposite sides of the bag and facing each other, the non-heat sealable assembly being located above the openable and re-closable assembly (and preferably parallel to the openable and re-closable assembly).

In one embodiment, at least one of the first or second non-heat sealable layer comprises at least one of the following materials:
a. PE
b. PP
c. PET
d. CPP.

In one embodiment, the first non-heat sealable layer is made up of a film that comprises two layers, the two layers being a first layer of the film of the first non-heat sealable layer and a second layer of the film of the first non-heat sealable layer, the first layer of the film of the first non-heat sealable layer comprising PET and the second layer of the film of the first non-heat sealable layer comprising CPP, wherein the two layers of the film of the first non-heat sealable layer are bonded together (preferably by an or the adhesive material).

In one embodiment, the second non-heat sealable layer is made up of a film that comprises two layers, the two layers being a first layer of the film of second non-heat sealable layer and a second layer of the film of second non-heat sealable layer, the first layer of the film of second non-heat sealable layer comprising PE or PP and the second layer of the film of second non-heat sealable layer comprising CPP, wherein the two layers of the film of second non-heat sealable layer are bonded together (preferably by an or the adhesive material).

In one embodiment, the bag further comprises a line of weakness to facilitate tearing, the line of weakness extending across (preferably extending horizontally across a lateral axis that is orthogonal to a vertical axis extending from top portion to bottom portion of the bag) the bag between two opposite sides of the bag.

In one embodiment, a tear notch is provided at one or each of the opposite sides of the bag at where the bag can be torn by a user.

In one embodiment, the line of weakness is provided along or adjacent the seal.

In one embodiment, the line of weakness is provided along or adjacent the or a breakable polymeric seal. In one embodiment, the bag further comprises a vent opening that is provided at one or each opposite sides of the bag at an upper zone where the upper compartment is located, the vent opening being configured to open during heating of the at least one food item to allow at least one of gas or steam to escape the containment region.

In one embodiment, the upper zone (upper compartment) comprises a gusset formation (upper gusset formation) that is configured to spread open due to pressure in the containment region.

In one embodiment, the upper zone (upper compartment) comprises a vent layer (vent tape) extending across (preferably extending horizontally across a lateral axis that is orthogonal to a vertical axis extending from top portion to bottom portion of the bag) the bag along a fold line of the gusset formation (upper gusset formation), the vent layer being configured to provide the vent openings.

In one embodiment, the vent layer (vent tape) comprises EVA.

In one embodiment, the vent layer (vent tape) comprises at least two layers, the two layers being a first layer of the vent layer (vent tape) and a second layer of the vent layer (vent tape), the first layer of the vent layer (vent tape) comprising EVA and the second layer of the vent layer (vent tape) comprising PET, wherein the two layers of the vent layer (vent tape) are bonded together (preferably by an or the adhesive material).

In one embodiment, the line of weakness functions as a hinge line so that when the first and second primary panels are close to each other, the hinge line allows drooping of the upper zone (upper compartment), and when the first and second primary panels move apart, the hinge line allows the upper zone (upper compartment) to be above the lower zone (lower compartment).

In a third aspect, the invention resides in a bag for heating (or cooking by heating) at least one food item in a microwave oven, the bag comprising:

a first primary panel and a second primary panel peripherally formed with and/or sealed to the first primary panel to form a containment region within the periphery, the bag being split into at least two zones by a breakable polymeric seal extending across (preferably extending horizontally across a lateral axis that is orthogonal to a vertical axis extending from top portion to bottom portion of the bag) the containment region to create a lower zone at a base of the bag and an upper zone located or configured to be located above the lower zone, the breakable polymeric seal being adapted to break and be in an open configuration when the containment region is heated thereby causing the at least food item in the containment region of the upper zone to move to the lower zone and mix with the at least one food item in the containment region of the lower zone.

In one embodiment, the upper zone comprises an upper compartment and the lower zone comprises a lower compartment, the upper and lower compartments being configured to store the at least one food item.

In one embodiment, the first primary panel is a front panel and the second primary panel is a back panel.

In one embodiment, the breakable polymeric seal in made out of EVA.

In one embodiment, the breakable polymeric seal comprises at least two layers, the two layers being a first layer of the breakable polymeric seal and a second layer of the breakable polymeric seal, the first layer of the breakable polymeric seal comprising EVA and the second layer of the breakable polymeric seal comprising CPP, wherein the two layers of the breakable polymeric seal are bonded together (preferably by an or the adhesive material).

In one embodiment, the breakable polymeric seal is configured to be bonded with a closure subassembly, the closure subassembly comprising two layers, the two layers being a first layer and a second layer, the first layer being OPP or RCPP and the second layer being CPP.

In one embodiment, the first layer of the breakable polymeric seal is configured to be bonded with the first layer of the closure subassembly.

In one embodiment, the breakable polymeric seal may be bonded to or formed as a part of the first primary panel and the closure subassembly layer may be bonded to or formed as the part of the second primary panel.

In one embodiment, the breakable polymeric seal may be bonded to or formed as a part of the second primary panel and the closure subassembly layer may be bonded to or formed as the part of the first primary panel.

In one embodiment, each of the first and second primary panels are made up of a film comprising at least one of the following materials:
a. PET
b. Nylon
c. RCPP.

In one embodiment, each of the first and second primary panels are made up of a film comprising three layers, the three layers being a first layer of the film, a second layer of the film and a third layer of the film, the first layer of the film comprising RCPP, the second layer of the film comprising Nylon and the third layer comprising PET, wherein the three layers of the film are bonded together (preferably by an or the adhesive material).

In one embodiment, the first layer is an internal layer facing the containment region, the second layer is an intermediate layer between the first and the third layer and the third layer is an external layer.

In one embodiment, the base of the bag is of a gusset formation (lower gusset formation) that is configured to spread open thereby providing footing for stability of the bag when the bag is in a standing position.

In one embodiment, pressure in the containment region causes the bag to be in the standing position.

In one embodiment, the bag further comprises an openable and re-closable sealing assembly.

In one embodiment, the openable and re-closable sealing assembly is located between the lower compartment and the breakable polymeric seal (preferably extending horizontally across a lateral axis that is orthogonal to a vertical axis extending from top portion to bottom portion of the bag and/or parallel to the breakable polymeric seal).

In one embodiment, the openable and re-closable sealing assembly is a zip lock (lower zip lock).

In one embodiment, the zip lock (lower zip lock) is made out of a PP or PE.

In one embodiment, the bag further comprises an opening at or near a top portion which is opposite the base through which the at least one food item is configured to enter the upper zone (upper compartment) of the bag.

In one embodiment, the opening comprises an openable and re-closable assembly (upper openable and re-closable assembly) which when opened allows access to the upper compartment (upper zone) through the opening and which when closed prevents access to the upper compartment (upper zone) though the opening.

In one embodiment, the openable and re-closeable assembly is a zip lock (upper zip lock).

In one embodiment, the zip lock (upper zip lock) is made out of a PP or PE.

In one embodiment, the bag further comprises a non-heat sealable assembly comprising a first non-heat sealable layer and a second non-heat sealable layer, the first and second non-heat sealable layers extending across (preferably extending horizontally across a lateral axis that is orthogonal to a vertical axis extending from top portion to bottom portion of the bag) the bag between two opposite sides of the bag and facing each other, the non-heat sealable assembly being located above the openable and re-closable assembly (preferably parallel to the openable and re-closable assembly).

In one embodiment, at least one of the first or second non-heat sealable layer comprises at least one of the following materials:
a. PE
b. PP
c. PET
d. CPP.

In one embodiment, the first non-heat sealable layer is made up of a film that comprises two layers, the two layers being a first layer of the film first non-heat sealable layer and a second layer of the film first non-heat sealable layer, the first layer of the film first non-heat sealable layer comprising PET and the second layer of the film first non-heat sealable layer comprising CPP, wherein the two layers of the film first non-heat sealable layer are bonded together by an or the adhesive material.

In one embodiment, the second non-heat sealable layer is made up of a film that comprises two layers, the two layers being a first layer of the film of the second non-heat sealable layer and a second layer of the film of the second non-heat sealable layer, the first layer of the film of the second non-heat sealable layer comprising PE or PP and the second layer of the film of the second non-heat sealable layer comprising CPP, wherein the two layers of the film of the second non-heat sealable layer are bonded together by an or the adhesive material.

In one embodiment, the bag further comprises a line of weakness to facilitate tearing, the line of weakness extending across (preferably extending horizontally across a lateral axis that is orthogonal to a vertical axis extending from top portion to bottom portion of the bag) the bag between two opposite sides of the bag.

In one embodiment, a tear notch is provided at one or each of the opposite sides of the bag at where the bag can be torn by a user.

In one embodiment, the line of weakness is provided along or adjacent the seal.

In one embodiment, the line of weakness is provided along or adjacent the breakable polymeric seal.

In one embodiment, the bag further comprises a vent opening that is provided at one or each opposite sides of the bag at an upper zone where the upper compartment is located, the vent opening being configured to open during heating of the food to allow gas and/or steam to escape the containment region.

In one embodiment, the upper zone (upper compartment) comprises a gusset formation (upper gusset formation) that is configured to spread open due to pressure in the containment region.

In one embodiment, the upper zone (upper compartment) comprises a vent layer (vent tape) extending across (preferably extending horizontally across a lateral axis that is orthogonal to a vertical axis extending from top portion to bottom portion of the bag) the bag along a fold line of the gusset formation (upper gusset formation), the vent layer being configured to provide the vent openings.

In one embodiment, the vent layer (vent tape) comprises EVA.

In one embodiment, the vent layer (vent tape) comprises at least two layers, the two layers being a first layer of the vent layer (vent tape) and a second layer of the vent layer (vent tape), the first layer of the vent layer (vent tape) comprising EVA and the second layer of the vent layer (vent tape) comprising PET, wherein the two layers of the vent layer (vent tape) are bonded together by an or the adhesive material.

In one embodiment, the line of weakness functions as a hinge line so that when the first and second primary panels are close to each other, the hinge line allows drooping, and when the first and second primary panels move apart, the hinge line allows the upper compartment to be above the lower compartment.

In a fourth aspect, the invention resides in method of using the bag as defined in any one of the above aspects, the method comprising at least the following steps:

providing the bag as defined in any one of the above statements;

introducing at least one item or food into the bag so that the upper and lower compartments are both filled with the at least one item or food;

sealing or closing any openings so that there is no leakage of the at least one item or food from the containment region and so that the at least one item or food in the upper compartment can be separated from the at least one item in the lower compartment at least until a pre-heating stage;

providing the bag useable to an end user.

In a fifth aspect, the invention resides in a method of manufacture of a bag for heating at least one item of commerce, the method comprising:

providing as a bag for heating the at least one item comprising a first primary panel and a second primary panel peripherally formed with and/or sealed to the first primary panel to form a containment region within the periphery, the bag being split into at least two zones by at least one seal extending across (preferably extending horizontally across a lateral axis that is orthogonal to a vertical axis extending from top portion to bottom portion of the bag) the containment region to create a lower zone at a base of the bag and an upper zone located or configured to be located above the lower zone, wherein the at least one seal is configured to allow any item in the upper zone to move and mix with any item in the lower zone when heated;

introducing the at least one item into the containment region so that the at least one item is located in one or both of the upper and lower zones; and

closing any opening of the bag by an application of heat and pressure so that there is no leakage of item(s) from the containment region and so that the at least one item in the upper compartment can be separated from the at least one item in the lower compartment at least until a pre-heating stage.

In a sixth aspect, the invention resides in a bag in a form of a binary pack that is microwaveable to provide a heated food item, the pack comprising or including (a) the package of the pack, (b) a first microwave heatable food content in a first compartment of the package, and (c) a second microwave heatable food content in a second compartment of the package;

wherein the package has a breakthrough zone able, under microwave input to the content(s), to connect the first and second compartments and to allow association of the contents of the first and second compartments; and wherein a part of the pack comprising the first compartment can be stabilised within a microwave apparatus with the breakthrough zone and the dependent part of the pack with the second compartment, such that microwave heating of the content of the first compartment is configured to cause the dependent part to rise during and/or subsequent to breakthrough thereby to use gravity to drop at least some of the content of the first compartment onto the content of the second compartment.

In one embodiment, the first microwavable food content is in a liquid or fluid form.

In one embodiment, the package is primarily of front and back panels and that part of the pack with the food compartment has a gusset formation (first gusset formation) or a footing formed by the gusset formation to provide the stability.

In one embodiment, that part of pack with the first compartment has a gusset formation (second gusset formation).

In one embodiment, the package is primarily of a heat sealable plastics film and/or plastics film laminate.

In one embodiment, the package has an openable access or opening to allow the heated and moistened food to be consumed.

In one embodiment, the package comprises openable vents that are configured to be opened from a pressure inside the first compartment.

In one embodiment, the vents may open after breakthrough of the breakthrough zone.

In one embodiment, a precursor of the package of the pack has at least one side closable and/or heat sealable opening to allow one or both the upper and lower compartments to receive content(s).

In one embodiment, the precursor has the breakthrough zone already sealed.

In a seventh aspect, the invention resides in a precursor package stock convertible to be a package of the bag in the form of a binary pack as defined in any of the statements of the sixth aspect.

In an eighth aspect, the invention resides in a fractioned retail pack for, all in a microwave apparatus, microwave heating of its contained water fraction and, by breakthrough and gravity association, moistening and heating of its contained food fraction.

In a ninth aspect, the invention resides in a feedstock of at least primarily plastics film or plastics film laminate to provide the packaging component for a customer usage to prepare a binary pack being the closed package with a breakthrough zone, food in a first compartment of the package, and a microwave heatable liquid or liquid product in a second compartment of the package, opening of breakthrough zone under microwave input to the binary pack to allow an association of the contents; wherein the feedstock has a gusset formation to provide, together with a suitable food, or the food provided with the feedstock, a stable, in microwave apparatus, footing of at least part of the binary pack with at least part of the breakthrough zone above the first compartment.

In a tenth aspect, the invention resides in a feedstock to provide a binary microwaveable food pack of a kind where a microwave heatable item in a first compartment of the package of the pack, when heated, breaks through a breakthrough zone to a second compartment of the pack; the feedstock being characterized in that one of or both of the first and second compartments prior to closure to confine its or their respect content is a bag, and being further characterized in that one of the first and second compartments in configured to define, in conjunction with its content, a stable support base below the breakthrough zone.

In an eleventh aspect, the invention resides in a binary pack microwaveable to provide a heated food product, the pack comprising or including (a) the package of the pack, (b) a food in one compartment of the package, and (c) a microwave heatable liquid or liquid product in a second compartment of the package;

wherein the package has a fluid breakthrough zone able, under microwave input to the liquid or liquid product, to connect the compartments

and to allow association of their contents; and wherein that part of the pack with the food compartment can be stabilised within a microwave apparatus with the fluid breakthrough zone, and the dependent part of the pack with the liquid or liquid product compartment, such that microwave heating of the liquid or liquid product will cause that dependent part to rise during and/or subsequent to breakthrough thereby to use gravity to drop at least some of the liquid or liquid product onto the food.

In one embodiment, the package is primarily of front and rear panels and that part of the pack with the food compartment has a gusset or a hybridised gusset footing to provide the stability.

In one embodiment, that part of pack with the liquid or liquid product compartment has a gusset or hybridised gusset.

In one embodiment, the package is primarily of a heat sealable plastics film and/or plastics film laminate.

In one embodiment, the package has an openable access to allow the heated and moistened food to be consumed.

In one embodiment, having fluid pressure openable vents from the liquid or liquid product compartment.

In one embodiment, said vents will open after fluid breakthrough of the fluid breakthrough zone.

In one embodiment, the precursor of the package of the pack has at least one slide closable and/or heat sealable opening to allow one or both compartment regions to receive content(s).

In one embodiment, the precursor has the breakthrough zone already sealed.

In a twelfth aspect, the invention resides in a precursor package stock convertible to be a package of a binary pack of any one of the statements of the eleventh aspect.

In a thirteenth aspect, the invention resides in a fractioned retail pack for, all in a microwave apparatus, microwave heating of its contained water fraction and, by breakthrough and gravity association, moistening and heating of its contained food fraction.

In a fourteenth aspect, the invention resides in a feedstock of at least primarily plastics film or plastics film laminate to provide the packaging component for a customer usage to prepare a binary pack being the closed package with a breakthrough zone, food in a first chamber of the package, and a microwave heatable liquid or liquid product in a second chamber, opening of breakthrough zone under microwave input to the binary pack to allow an association of the contents; wherein the feedstock has a gusset or hybridised gusset form to provide, together with a suitable food, or the food provided with the feedstock, a stable, in microwave apparatus, footing of at least part of the binary pack with at least part of the breakthrough zone above the first chamber.

In a fifteenth aspect, the invention resides in a feedstock to provide a binary microwaveable food pack of a kind where a microwave heatable fluid in one chamber of the package of the pack, when heated, breaks through a breakthrough zone to a food chamber of the pack; the feedstock being characterized in that one of or both of the chambers prior to closure to confine its or their respect content is a pouch, and being further characterized in that that part of the feedstock to confine the food will or can define, in conjunction with its food content, a stable support base below the breakthrough zone.

Other aspects of the invention may become apparent from the following description which is given by way of example only and with reference to the accompanying drawings.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following description are simply exemplary embodiments of the invention. Hence, specific dimensions and other physical characteristics related to the embodiments disclosed herein are not to be considered as limiting.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprises’ or ‘comprised’ or ‘comprising’ is used in relation to the apparatus or to one or more steps in a method or process.

As used hereinbefore and hereinafter, the term “and/or” means “and” or “or”, or both.

As used hereinbefore and hereinafter, “(s)” following a noun means the plural and/or singular forms of the noun.

When used in claim and unless stated otherwise, the word ‘for’ is to be interpreted to mean only ‘suitable for’, and not for example, specifically ‘adapted’ or ‘configured’ for the purpose that is stated.

Unless otherwise specifically stated, the word “zip lock” as used hereinbefore and hereinafter may mean a closure arrangement comprising a first closure profile including a first interlocking closure member and a second closure profile including a second interlocking closure member, the first and second interlocking closure members being arranged and configured to selectively engage to be in a closed configuration and disengage to be in an open configuration. The same rational should apply for the words “upper zip lock” and “lower zip lock” as used hereinafter.

### BRIEF DESCRIPTION OF THE DRAWINGS

Preferred embodiments of the invention will be described by way of example only and with reference to the drawings, in which:

FIG. 1 shows a front elevation of a bag according to one preferred embodiment of the present invention.

FIG. 2 shows the front elevation view of the bag of FIG. 1 showing the gusset formation.

FIG. 3 shows an isometric view of the bag of FIG. 1.

FIG. 4 shows a side elevation view of the bag of FIG. 1

FIG. 5 shows an isometric view of the bag of FIG. 5 showing a gusset formation (lower gusset formation) at a base of the bag in a fully spread open position.

FIG. 6 shows a cross sectional view of the bag of FIG. 1 along I-I axis

FIG. 7 shows a top isometric view of the bag of FIG. 1 showing the opening at the top portion of the bag.

FIG. 8 shows a top isometric view of a lower compartment of the bag of FIG. 1 where the lower compartment of the bag functions as a self-standing food bowl.

FIG. 9 shows a bag where both the upper and lower compartments of the bag are filled with food items.

FIGS. 9A-9D are cross sectional views of the bag of FIG. 9 and show sequential movement of the upper zone comprising the upper compartment of the bag with respect to the lower zone comprising the lower compartment and release of the contents of the upper compartment to the lower compartment.

FIG. 10 shows a filled bag according to another preferred embodiment of the present invention.

FIG. 11 shows a bag according to a yet another preferred embodiment of the present invention

FIG. 12 shows a bag according a a further preferred embodiment of the present invention.

FIGS. 13-18 sectional views of the various portions of the bag of FIG. 1.

FIG. 19 shows a view of a closure subassembly for use in the bag of according to the embodiments of FIGS. 1 to 18.

FIGS. 20 and 21 show stages of a bonding of the closure subassembly of FIG. 19 to another panel.

FIG. 22 shows the assembly of FIG. 21 as part of a bag with a first mode opening.

FIGS. 23 and 24 show stages of a bonding of the part of the bag of FIG. 22.

FIG. 25 shows the part of the bag of FIG. 24 with a header removed.

FIG. 26 shows the part of the bag of FIG. 25 with a second mode opening of the bag between two closure elements.

FIGS. 27 and 28 show a further embodiment of the part of the bag shown in FIGS. 24 and 25.

### DETAILED DESCRIPTION OF PREFERRED EMBODIMENTS

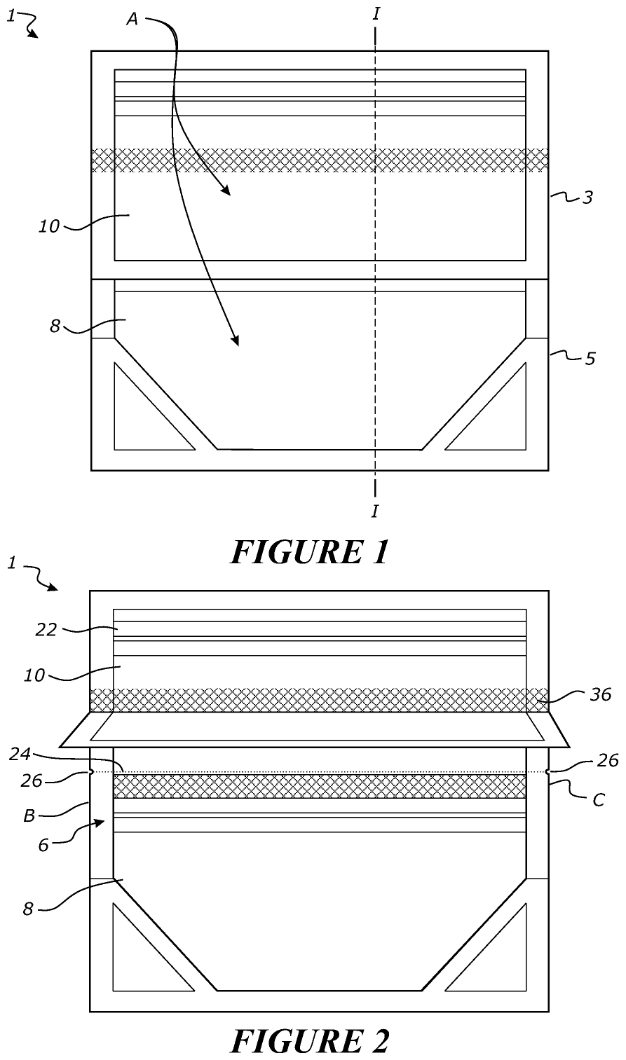

With reference to FIGS. 1-9 and 9A-9D there is shown a bag 1 according to one preferred embodiment of the present invention. The bag 1 is suitable for containing at least one item (preferably at least one food item) to be heated or cooked by heating inside the bag 1. The bag is preferably predominantly made of plastic and given it is or is to be in contact with item such as food, the materials used are suitable for this application. The materials are preferably of a food grade plastic including being such when subjected to temperatures enough to sufficiently heat the food for subsequent consumption.

The bag 1 comprises a first primary panel 2. The first primary panel 2 may also be referred to as a front panel. The bag 1 also comprises a second primary panel 4. The secondary primary panel 4 may also be referred to as a back panel. The second primary panel 4 is peripherally formed with and/or sealed (such as heat sealed and/or otherwise sealed) to the first primary panel 2 to form a containment region A within the formed/heat sealed periphery. The bag 1 preferably has its front and back panel made from two sheets that are heat sealed to each other. Alternatively, the front and back panel 2, 4 may be made by folding one sheet in a manner so that the fold defines one part of the periphery of the bag, the rest at least in part heat-sealed to define the containment region A.

The containment region A is preferably split into two compartments by at least one seal 6 extending across (preferably extending horizontally across a lateral axis that is orthogonal to a vertical axis extending from top portion to bottom portion of the bag) the containment region A. The seal 6 extends from one perimeter region B of the bag to another perimeter region C of the bag. At the seal 6 the front panel and back panel are joined together to create the two compartments 8 and 10. The two compartments are a lower compartment 8 located proximal to a base (which is the bottom portion) of the bag 1 and an upper compartment 10 located above the lower compartment 8, the upper and lower being in the reference frame as drawn in the images and also in the reference frame when in use during heating as will herein be described. As shown in the figures the upper zone 3 of the bag 1 comprises the upper compartment 10 and the lower zone 5 of the bag 1 comprises the lower compartment 8. Although, only two compartments 8, 10 are shown in the Figures, the bag may comprise more than two compartments. For example, there may be three, four or five or more compartments that are located adjacent and parallel to each other each compartment being separated from another compartment using at least one seal (or a breakthrough zone comprising at least one seal) in a similar manner how compartments 8 and 9 are located and separated from each other.

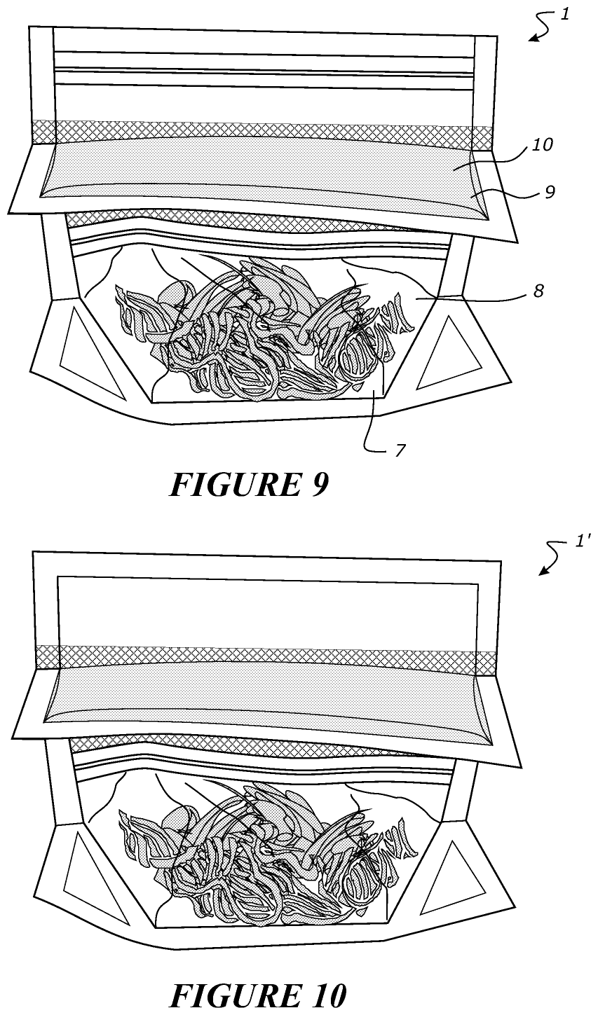

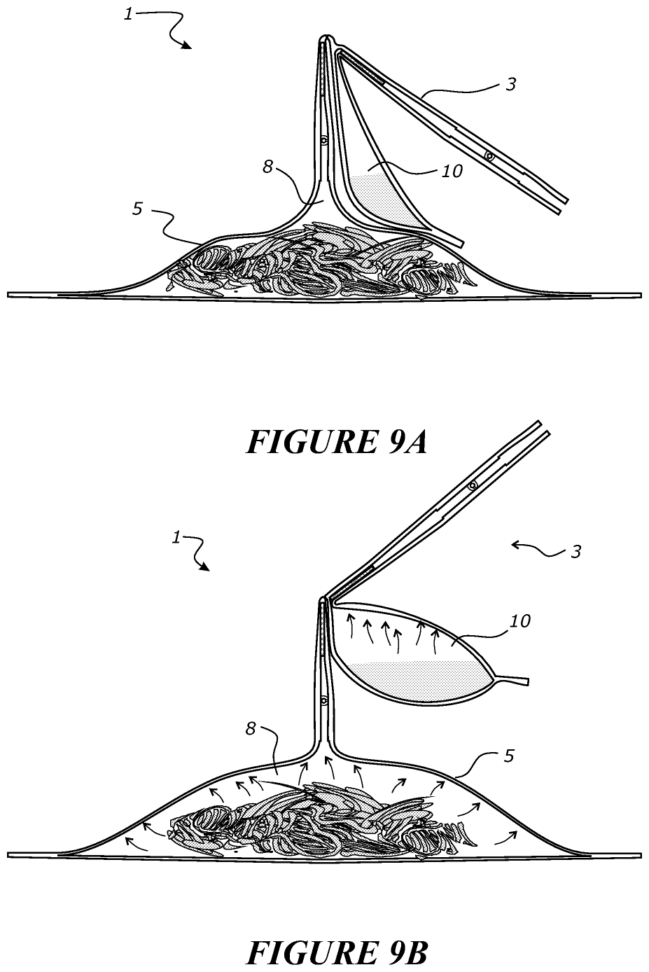

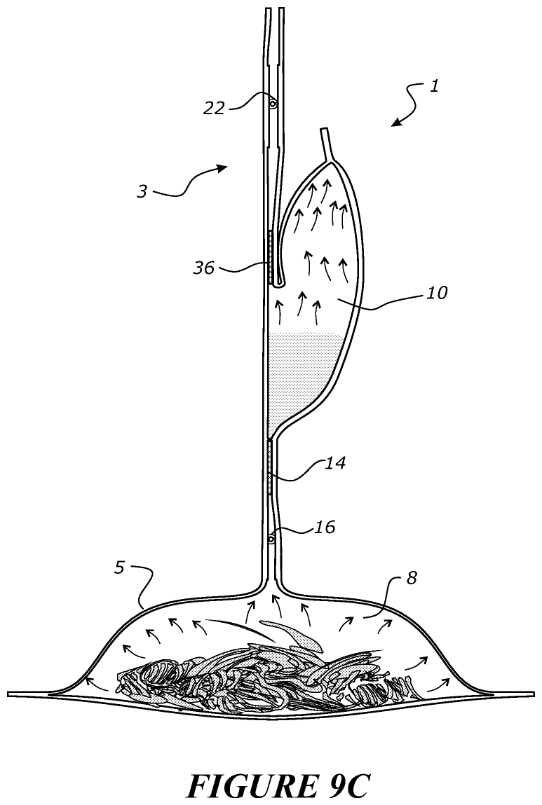

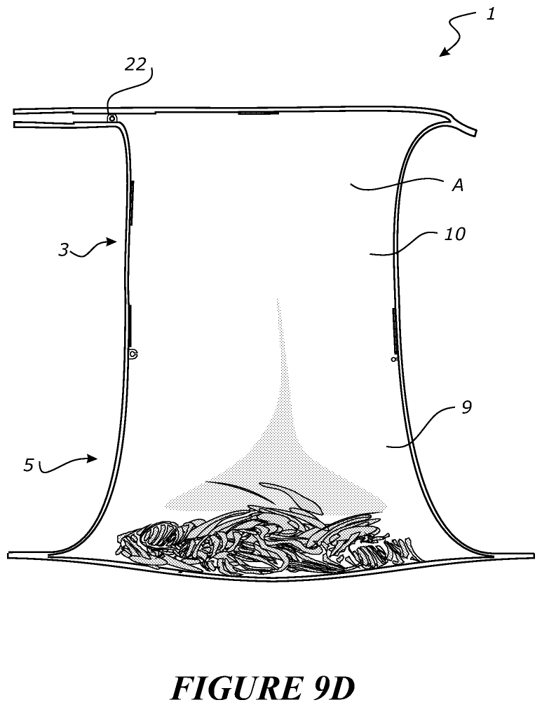

The two compartments 8, 10 are each configured to contain the at least one item or admixture 7, 9, preferably a food item (which may include food ingredient) or items as shown in FIG. 9.

The bag 1 and its content may be heated. This may occur after placing the bag 1 with contents inside in a microwave oven. Before heating of the items 7, 9, the seal 6 is configured to be in a closed configuration thereby separating the items 7 in the lower compartment 8 from the item 9 in the upper compartment 10. During heating of the items 7, 9, the seal 6 is configured to open and be in an open configuration so that the item 9 in the upper compartment 10 can drop into the lower compartment 8 due to gravity and mix with the item 7 in the lower compartment 8.

The lower and upper compartments 8, 10 may contain the same or different items. In one preferred embodiment, the upper compartment 10 contains a liquid/fluid such as water and a lower compartment 8 contains a food item or ingredient that is to be cooked as shown in FIGS. 8 and 9. Air is or may also be present in one of both lower and upper compartments 8, 10.

In one embodiment, each of the first and second primary panel 2, 4 is preferably made up of a film comprising at least one of the materials selected from PET, Nylon and RCPP. In one embodiment, each of the first and second primary panels 2, 4 are made up of a film comprising three layers, the first layer comprising RCPP, the second layer comprising Nylon and the third layer comprising PET. The three layers of the film are bonded together preferably by an adhesive material. The first layer of the film may be an internal layer facing the containment region, the second layer of the film may be the external layer or is the intermediate layer between the first layer of the film and the third layer of the film. The third layer of the film may be an external layer.

In the embodiment shown, the seal 6 is a breakable polymeric seal 14 that is configured to open and be in the open configuration upon heating. For example, the breakable polymeric seal 14 may comprise an adhesive attachment between the front and back panel bonding these panels together. The adhesive attachment may clear or function when heated to a particular level thereby opening the breakable seal 14. This may occur by a weakening of the adhesive bond when the breakable polymeric seal 14 is heated at or to a particular temperature. Temperature may affect the strength of the adhesive bond. An increase in temperature may make the adhesive less adherent. The release may occur due to an increase in pressure on the breakable polymeric seal 14 by virtue of the panels 2, 4 wanting to move apart from each other at the breakable polymeric seal 14 due to increasing gas pressure in one of both the lower and upper compartments 8, 10. Or the release or clearing of the adhesive attachment may occur due to a combination of heating of the adhesive and pressure on the breakable polymeric seal 14 to pry or pull the breakable polymeric seal 14 to an open configuration.

As an example, the adhesive bond may established to break when the compartment temperature reaches around 80-90 degrees Celsius. The zip-lock closure may open when the compartment temperature is around 100 degrees Celsius. If the air pressure in a compartment is larger in the lower compartment than the air pressure in the upper compartment it may require the compartment to get to a temperature to cause the zip-lock to open first before the pressure and heat can then affect the adhesive seal above.

The breakable polymeric seal 14 is preferably a one-off seal which means once the breakable polymeric seal 14 is in open configuration, it no longer can be closed.

In a preferred form the exterior layer of the polymeric seal 14 may be made using EVA. A glue-like attachment can be created between EVA and the OPP/RCPP. The glue like attachment can also be created by other suitable materials. A food grade glue may be used.

The embodiment of FIGS. 1 to 10 also show an openable and re-closable sealing assembly preferably in a form of zip lock 16. The zip lock 16 is located between the lower compartment 8 and the breakable polymeric seal 14 and intermediate the front and back panels 2, 4.

The zip lock 16 comprises of two complementary strips 16A, 16B (see FIG. 10) which may be formed from PP or PE.

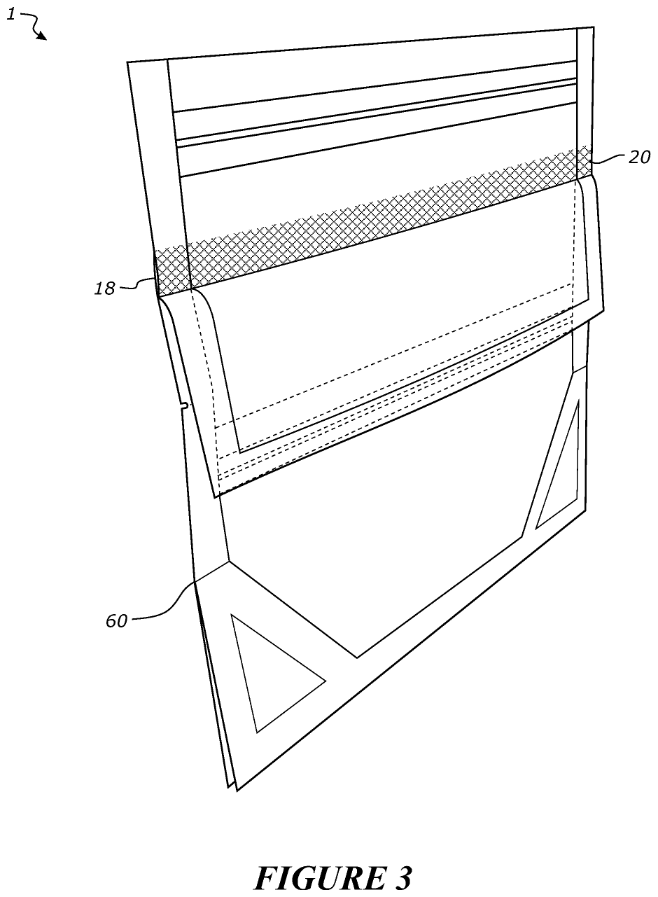

The breakable polymeric seal 14 and the zip lock 16 may create an openable separation between the lower compartment 8 and the upper compartment 10 of the bag 1 that may be formed from a film (as described later). The zip lock 16 is able to prevent the items 7, 9 in the lower compartment 8 and upper compartment 10 from mixing until a user initiated act and/or the pressure (e.g. air/gas pressure inside the containment region) causes the zip lock 16 and the breakable polymeric seal 14 to both open. For example, if the upper compartment 10 contains item 7 in the form of water and a lower compartment 8 contains item 9 in the form of rice or noodles, a user may place the bag 1 in a microwave oven and heat the contents. The heat such as from the steam will cause the breakable polymeric seal 14 to open especially upon sufficient heat and/or internal pressure build in one of both compartments of the bag. The increase in heat may cause an increase in pressure (e.g. air/vapor pressure) and hence expansion of the lower compartment 8 and such expansion will cause the zip lock 16 to pry apart and open. Opening of both the zip lock 16 and the breakable polymeric seal 14 then will allow the water in the upper compartment 10 to drop into the lower compartment 8 and mix with the rice or noodles in the lower compartment 8 and subsequently allow the rice or noodles to be cooked in the lower compartment 8. Any continued heating and resulting increase of the internal pressure of the bag may optionally result in venting of the pressure via optional vent openings 18, 20 located at a periphery region of the bag as shown in FIG. 3. This is preferably in a location above the level at where water may settle in the bag after opening of the lower and upper compartments 8, 10 to each other.

In one embodiment, the breakable polymeric seal 14 may comprise or may be made out from a polymeric materials e.g. EVA which is a copolymer. In one embodiment, the breakable polymeric seal comprises at least two layers, the first layer comprising EVA and the second layer comprising CPP, wherein the two layers are bonded together preferably by an adhesive material. A pressure may be applied to press the two layers together to cause them to bond together.

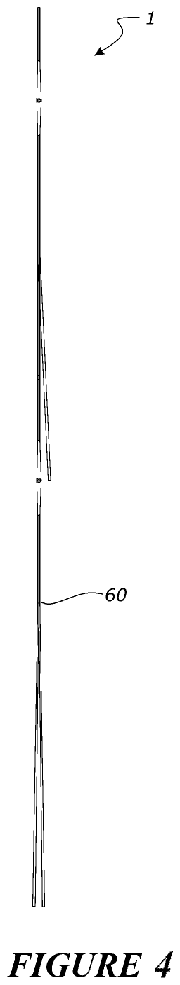

As shown in FIGS. 4 and 5, the base of the bag 1 may be of a gusset formation 60 (lower gusset formation) that is configured to spread open thereby allowing the bag 1 to self-stand. The gusset formation 60 can therefore provide a footing for stability of the bag 1 when the bag 1 is in standing position in a microwave oven. This gusset formation 60 is at the lower compartment 8 of the bag. The base is hence part of the lower compartment 8.

In one optional embodiment, the bag 1 may initially be placed in a non-standing state inside the microwave and when heat and pressure starts to build up inside in the containment region A, such heat and pressure then causes the bag 1 to be in the standing position. Increase in internal pressure in one of both the lower and upper compartments 8, 10 will cause the bag 1 to bloat by the front and back panels 2, 4 moving away from each other. The bag 1 is hence packed with items 7, 9 in a manner to not present the bag and its compartments in a bloated condition before heating. Hence in a pre-heated condition the bag 1 is of a configuration not of maximum volume. This hence provides the bag 1 with a capacity to increase in volume upon an increase in internal pressure caused by heating the contents of the bag 1. The heat or steam and/or internal pressure will as result cause the breakable polymeric seal 14 to open. The increase in heat and pressure (e.g. air pressure and vapor pressure) also causes the expansion of the volume of lower compartment 8 and such expansion will cause the zip lock 16 to pry apart and open. This then will allow the water in the upper compartment 10 to drop into the lower compartment 8 due to gravity and mix with the rice or noodles in the lower compartment 8 and subsequently allow the rice or noodles to be cooked in the lower compartment 8. In one embodiment, in use the upper zone 3 comprising the upper compartment 10 is initially in a drooped condition relative the standing lower compartment in the lower zone 5, and will move from being adjacent the lower compartment 8 to being above as shown sequentially in FIGS. 9A-9D. As shown in FIG. 9A, the upper zone 3 comprising the upper compartment 10 may initially be in a drooped condition relative the standing lower compartment 8 in the lower zone 5 and be adjacent the lower compartment 12 in the lower zone 5. At such position, even if part of the breakable polymeric seal 14 of zip-lock 16 is compromised and opened, the fact that the upper compartment 10 is below the upper/lower compartment interface (at the seal region) means that item e.g. water in the upper compartment 10 will not tip into the lower compartment 8 until a sufficient internal pressure has built that causes the upper compartment 10 to move up and above the lower compartment 8, as a result, pour the item e.g. water into the lower compartment 8. When so drooped the front and back panels 2, 4 at the breakable polymeric seal 14 are contiguous each other as seen in FIG. 9A. In this configuration a notational hinge axis is defined by front and back panels to allow for the drooped configuration to be assumed. FIG. 9B shows the upper zone comprising the upper compartment 10 being moved slightly up and above the lower compartment 8. FIG. 9C shows the upper zone 3 comprising upper compartment 10 moved up and above the lower zone 5 comprising the lower compartment 8 and FIG. 9D shows the zip lock 16 and breakable polymeric seal opened due to pressure increase thereby causing the item e.g. water in the upper compartment 10 to drop inside the lower compartment 8. In FIGS. 9B-9C, the arrows inside the lower compartment 8 and the upper compartment 10 show the direction of the internal pressure inside the lower and upper compartments 8, 10 due to increase in the temperature inside the lower and upper compartments 8, 10. As shown, as the internal pressure in the lower and upper compartments 8,10 increases, so does the inside volume of the lower and upper compartments 8, 10. This is because as the internal pressure in the upper and lower compartments 8, 10 increase the force acting against the inside walls (formed by the front and rear panels 2, 4) also increases, thereby increasing the separation distance between the walls in each of the lower and upper compartments 8, 10.

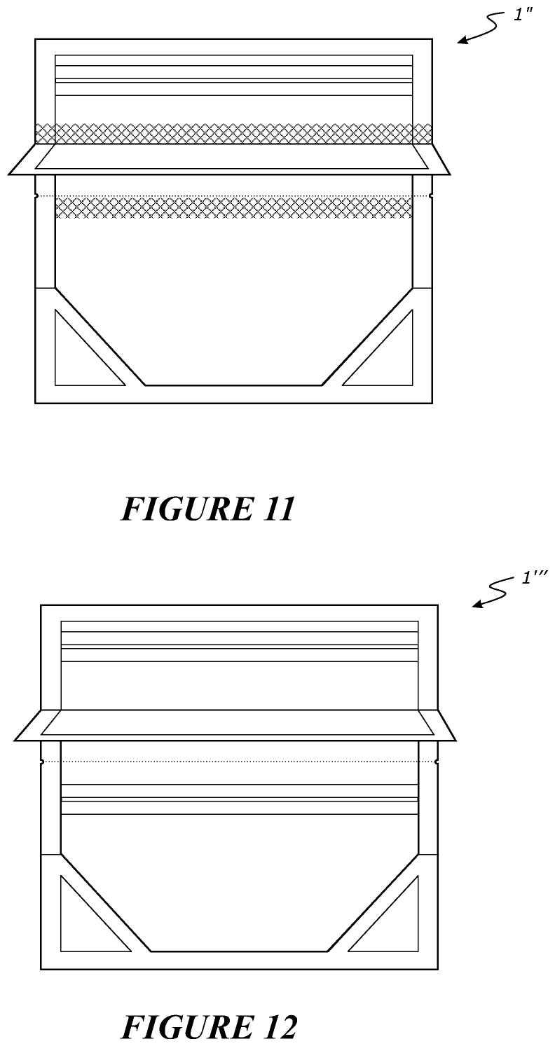

In one embodiment, the seal 6 may be in the form of a breakable polymeric seal 14 only (i.e. no zip lock). This is shown in FIG. 11. The bag 1″ of FIG. 11 is same as the bag 1 of FIGS. 1-9 save that the bag 1″ does not comprise zip lock 16. In alternative embodiment as shown in FIG. 12, the seal 6 may be in the form of the openable and re-closable sealing assembly such as zip lock 16 only (although many other suitable form of openable and re-closable sealing assembly may be used). The bag 1′″ of FIG. 12 is same as the bag 1 of FIGS. 1-9 save that the bag 1′″ does not comprise breakable polymeric seal 14.

Having both the breakable polymeric seal 14 and zip lock 16 as seals is advantageous because that allows double layer of protection which mean even if either one accidently breaks, then another one can still prevent the items in the lower and upper compartments 8, 10 from mixing. In other words, if the zip lock 16 is accidently opened, the breakable polymeric seal 14 may still prevent the items in the upper and lower compartments from mixing. Similarly, if the breakable polymeric seal 14 is accidently opened (for example by usually high ambient temperature during storage/transportation), the zip lock 16 may still prevent the items 7, 9 in the lower and upper compartments 8, 10 from mixing. The use of the zip-lock 16 also has the additional advantage of allowing a user to re-close the lower compartment. This may be desirable for example when there is still some leftover food item inside the lower compartment 8 and a user decides to temporarily store the lower compartment containing the leftover food item (e.g. in a refrigerator) for later consumption. The user can reclose the zip lock 16 to seal the leftover food in the lower compartment. Upper compartment 10 may by then have been separated from the lower compartment so hence the provision of the zip-lock 16 at the mouth entrance 21 to the lower compartment 8.

Apart from by pressure (such as air or vapor pressure) inside one of both of the lower and upper compartments 8, 10, the zip lock 16 and breakable polymeric seal 14 can also be opened by some other means, such as (a) two vacuum suctions pulling the bag's front and back panels apart, (b) pressing, (c) external hooks or Velcro pulling the bag's opposite sides apart, (d) chemical reaction of the contents of the bag creating an internal air pressure (e) manually gripping and pulling the front and back panels 2, 4 apart by a user's hand/fingers

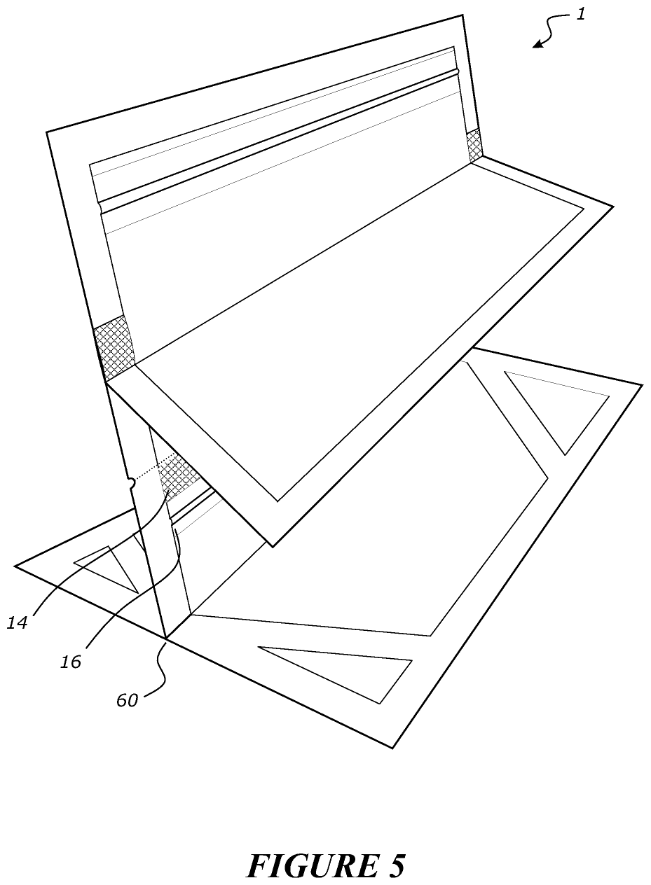

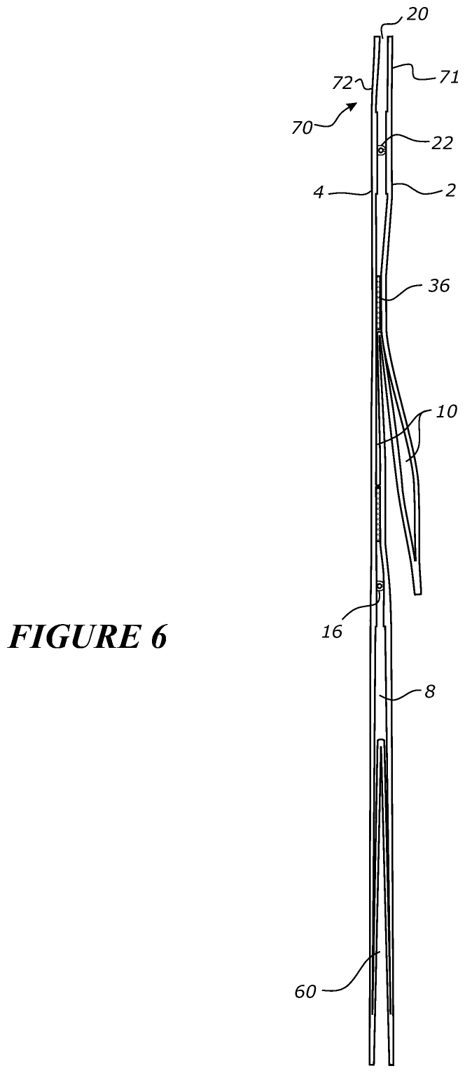

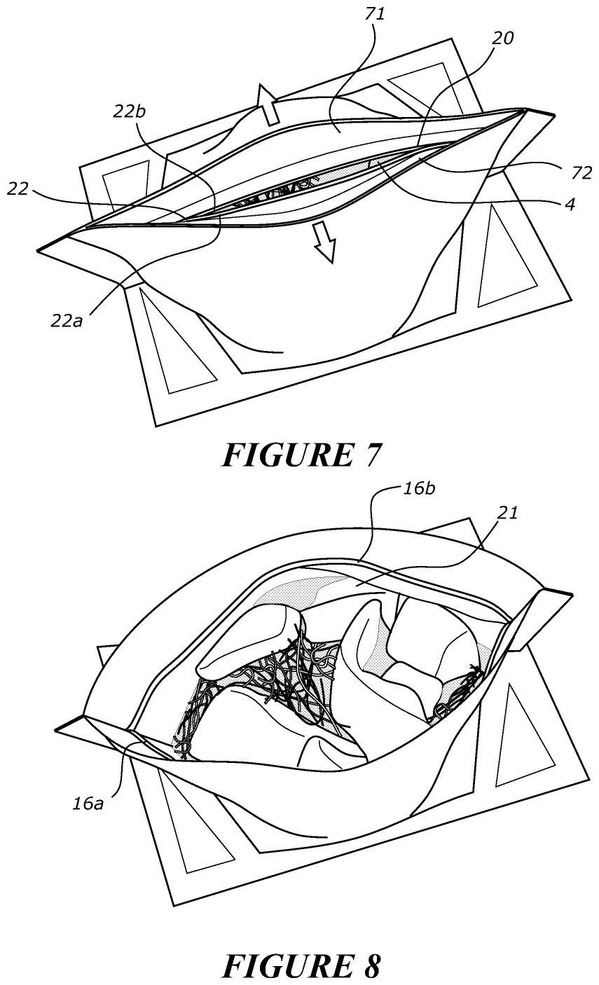

As shown in FIGS. 6 and 7, the bag 1 optionally comprises an opening 20 at or near a top portion which is opposite the base through which the at least one item is configured to enter the upper compartment 10 of the bag 1.

The opening 20 comprises an openable and re-closable assembly which when opened allows access to the upper compartment through the opening and which when closed prevents access to the upper compartment 10 though the opening 20. In the embodiment shown the openable and re-closeable assembly is a zip lock 22 although many other suitable form of openable and re-closeable assembly may be used. In one embodiment, the bag comprises a non-heat sealable assembly 70 comprising a first non-heat sealable layer 71 and a second non-heat sealable layer 72. The first and second non-heat sealable layers 71, 72 extend across (preferably extending horizontally across a lateral axis that is orthogonal to a vertical axis extending from top portion to bottom portion of the bag) the bag 1 between two opposite sides of the bag and face each other as shown in FIG. 7. The non-heat sealable assembly is located above the openable and re-closable assembly, i.e the zip lock 22 (i.e. upper zip lock 22). As shown, the non-heat sealable assembly may be located to be parallel to the openable and re-closable assembly.

The first and/or second non-heat sealable layer(s) comprise(es) at least one of PE, PP, PET, CPP.

In one embodiment, the first non-heat sealable layer 71 is made up of a film comprising two layers. The first layer of the film of the first non-heat sealable layer 71 may comprise PET and the second layer of the film of the first non-heat sealable layer 71 may comprise CPP. The two layers of the film of the first non-heat sealable layer 71 are bonded together preferably by an adhesive material.

The second non-heat sealable layer 72 may also made up of a film comprising two layers. The first layer of the film of the second non-heat sealable layer 72 may comprise PE or PP and the second layer of the film of the second non-heat sealable layer 72 may comprise CPP. The two layers of the film of the second non-heat sealable layer 72 are bonded together preferably by an adhesive material.

It is to be noted that the opening 20, zip lock 22 and non-heat sealable assembly 70 are all optional and depending upon the user's requirements, the bag may not comprise any opening 20, zip lock 22 and non-heat sealable assembly 70. For example, the bag 1 that is already pre-packaged with one or more items 7, 9 in the containment regions may no longer need any opening similar to opening 20 and therefore once the item(s) is/are placed inside the containment region, the first and second primary panels may be permanently heat sealed to ensure that there is no opening similar to opening 20. Similarly zip lock 22 and non-heat sealable assembly 70 may also be optional in such cases. One example of such bag is shown in FIG. 10 where the bag 1′ is same as the bag of FIGS. 1-9 except that the the first and second primary panels of bag 1′ are permanently heat sealed and no zip lock and non-heat sealable assembly is present at the top portion of the bag 1′.

One half of the zip lock 22 may be sealed onto the width-extended part of the CPP layer. The other half (opposite half) of the zip lock 22 may be sealed onto the width-extended part of an opposite tape made of PE or PP as its first layer and CPP as its second layer. As PET cannot be heat sealed to PE or PP, the opening of the bag 1 above the zip lock 22 cannot be heat sealed. In order to make it harder to open the top portion of the bag 1, the back of one half of zip lock 22 may be heat sealed onto the bag (i.e. CPP layer may be sealed to the RCPP layer of the bag), while the other one half of the z zip lock 22 may not be so heat sealed onto the bag 1.

The bag 1 may optionally comprise a line of weakness 24 to facilitate tearing. The line of weakness 24 may extending across (preferably extending horizontally across a lateral axis that is orthogonal to a vertical axis extending from top portion to bottom portion of the bag) the bag 1 between two opposite sides of the bag as shown in FIG. 2. The line of weakness 24 may be provided along or adjacent the seal 6. In one embodiment, the line of weakness may be provided along or adjacent the breakable polymeric seal 14.

A tear notch 26 may optionally be provided at one or each of the opposite sides B, C of the bag at where the bag 1 can be torn by a user. A tear notch 26 provided at such peripheral region of the bag and the line of weakness 24 provided across (preferably extending horizontally across a lateral axis that is orthogonal to a vertical axis extending from top portion to bottom portion of the bag) the bag will allow a user to remove the upper compartment 10 of the bag 1 and use the lower compartment 8 as a food bowl as shown in FIG. 8. As shown in FIG. 8, the gusset formation 60 at the base allows the lower compartment 8 to function as a self-standing food bowl.

As shown in FIG. 3 vent opening 18, 20 may optionally be provided at one or each opposite sides or periphery of the bag at an upper zone 3 where the upper compartment 10 is located. The vent opening 18, 20 may be configured to open during heating of the item(s) to allow gas and/or steam to escape the containment region A.

The upper zone 3 may comprise a gusset formation 36 (upper gusset formation) that is configured to spread open due to pressure in the containment region. As shown in FIG. 2, the gusset formation 36 may comprise a V junction that extends across (preferably extending horizontally across a lateral axis that is orthogonal to a vertical axis extending from top portion to bottom portion of the bag) the bag from the vent opening 32, 34. This allows the front and back panel 2, 4 to separate from each other as the bag pressure increased. This allows for the upper compartment 10 to change shape to or towards a condition suited to allowing a previously drooping upper compartment to assume an erect condition located above lower compartment. The line of weakness 24 may act as a hinge line so that when the front and back panel 2, 4 are close to each other hinge line allows drooping of the upper compartment 10, and when the front and back panels 2, 4 move apart, the hinge line allows the upper compartment 10 to be above the lower compartment 8.

Apart from holding liquid/fluid in one compartment and food items such as rice, noodles, or tea bags in the other compartment, the bag can also hold different food items which require mixing when being heated up or cooked.

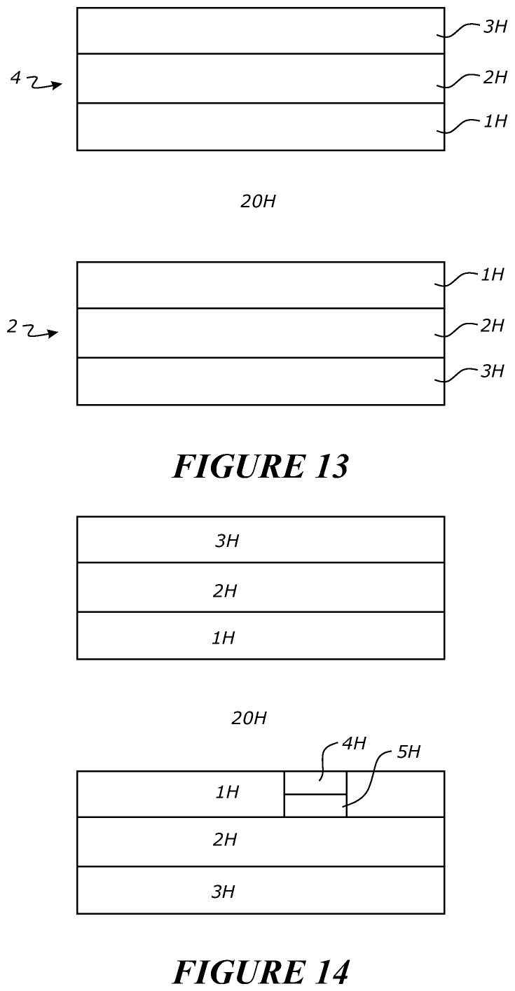

Some examples of the material and construction of various portions of the bag 1 will now be described with reference to FIGS. 13 to 18.

As shown in FIG. 13, preferably the first and second primary panels 2, 4 are made up of a film comprising three layers (or plies), the first layer (or ply) 1H comprising RCPP, the second layer (or ply) 2H comprising Nylon and the third layer (or ply) 3H comprising PET, wherein the three layers (or plies) 1H, 2H, 3H are bonded together preferably by an adhesive material. The inside space of the bag 1 is shown by reference numeral 10H in FIG. 13.

As shown in FIG. 14, vent layer (vent tape) preferably comprises at least two layers (or plies), the first layer (or ply) 4H comprising EVA and the second layer (or ply) 5H comprising PET. The two layers (or plies) may be bonded together preferably by an adhesive material. In FIG. 14 the vent layer (vent tape) is shown as being bonded to the first primary panel 2. However, it may be possible that the vent layer (vent tape) is bonded to the second primary panel 4.

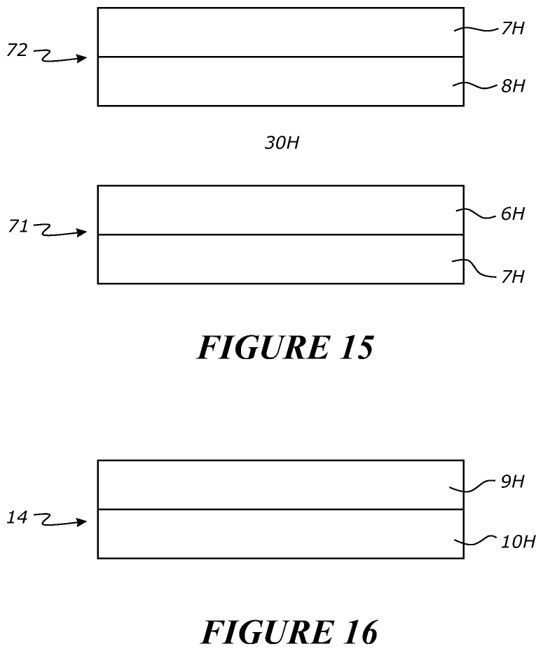

As mentioned above, the bag 1 preferably comprises a non-heat sealable assembly 70 comprising a first non-heat sealable layer 71 and a second non-heat sealable layer 72. As shown in FIG. 15, the first non-heat sealable layer 71 may be made up of a film comprising two layers (or plies), the first layer (ply) 6H comprising PET and the second layer (or ply) 7H comprising CPP. The two layers (or plies) may be bonded together by an adhesive material. Similarly, the second non-heat sealable layer 72 may also made up of a film comprising two layers, the first layer (or ply) 8H comprising PE or PP and the second layer (or ply) 7H comprising CPP. The two layers (or plies) may be bonded together preferably by an adhesive material. In FIG. 15, the inside space between the first non-heat sealable layer 71 and the second non-heat sealable layer 72 is shown by reference numeral 20H. By having such construction, the first and second non-heat sealable layers 71, 72 cannot be sealed together because PET does not seal with PE/PP.

The breakable polymeric seal is preferably of a two-ply construction comprising of a first layer (or ply) 9H of EVA and a second layer (or ply) 92H of PET. This is shown in FIG. 16.

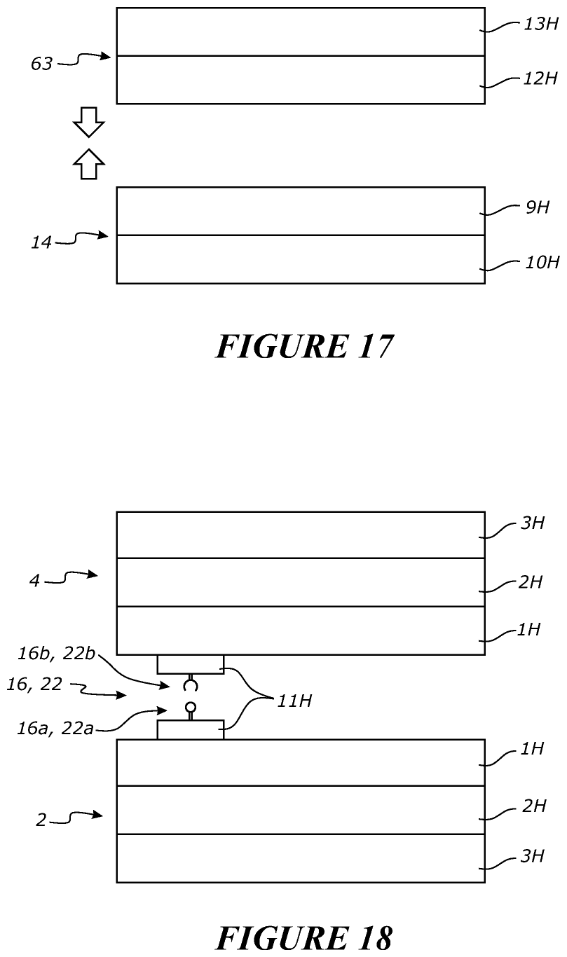

As shown in FIG. 17, the breakable polymeric seal 14 may be configured to bonded with a closure subassembly 63 comprising two layers (or plies), the first layer (or ply) being OPP or RCPP and the second layer (or ply) being CPP. Attachment between EVA and OPP/RCPP provides a glue-like attachment that can prevent item such as food in the lower compartment from entering into the upper compartment in the zip lock 16 is forced open accidently during transportation or handling. The breakable polymeric seal 14 may be bonded to or formed as a part of the first primary panel 2 and the closure subassembly 63 may be bonded to or formed as the part of the second primary panel 4. Alternatively, the closure subassembly 63 may be bonded to or formed as the part of the first primary panel 2 and the breakable polymeric seal 14 may be bonded to or formed as the part of the second primary panel 4.

The zip lock 16, 22 of bag 1 may be made out of a PP or PE. FIG. 18 shows a zip lock 16, 22 that is bonded to the primary panels 2, 4 of bag 1. The PP or PE layer (or ply) is shown by reference numeral 11H. Although, the figure shows male closure member 16a, 22a of the zip lock 16, 22 being bonded to the first primary panel 2 and the female closure member 16b, 22bb of the zip lock 14, 16 being bonded to the second primary panel 4 this can be reversed, i.e. the female closure member, 16b, 22b of the zip lock 16, 22 may be bonded to the first primary panel 2 and the male closure member 16a, 22a of the zip lock 14, 16 being bonded to the second primary panel 4.

For zip lock 22 located at the top portion of the bag 1—the strip or ply of one of the closure members 22a, 22b may not have its back heat sealed to the bag. Thus, due to the non-equal structure between the two opposite sides of the zip lock 22, it becomes difficult to force open the zip lock 22 from expanding pressure inside the bag 2, more particularly expanding pressure inside the upper compartment 10 of the bag 1.

Similarly, for zip lock 16 located at a lower portion of the bag 1, strip or ply of both of the closure members 22a, 22b may not have their back heat sealed to the bag. Thus, due to its equal structure, it becomes easy to open the zip lock 16 from internal pressure of the lower compartment 8 of the bag 1.

### Closure Subassembly

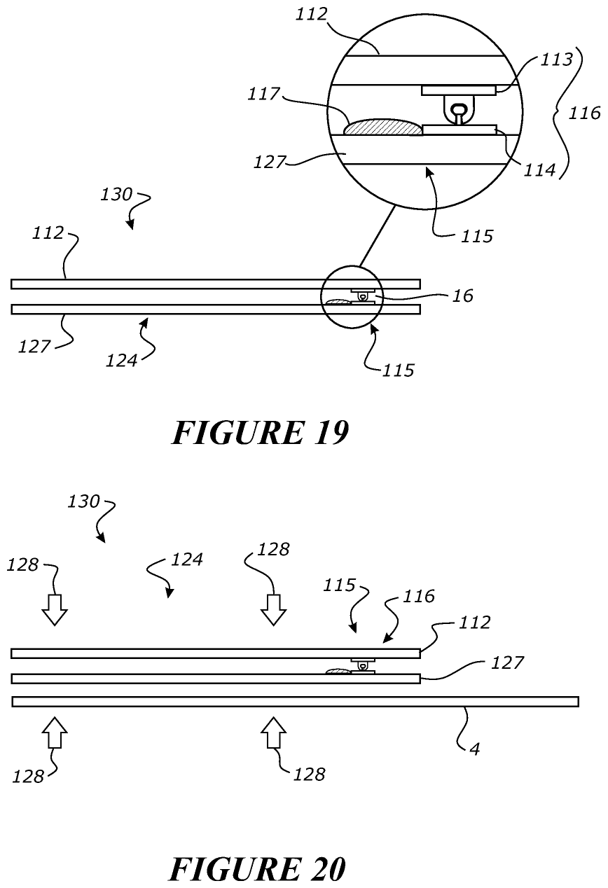

The zip lock 16 and the breakable polymeric seal 14 may form part of a closure subassembly 130 in a manner as described below with reference to FIGS. 19-28.

In a preferred embodiment the zip lock 16 comprises closure elements 113 and 114 may be provided as part of a closure subassembly 130. Such a closure subassembly 130 is shown in FIG. 19. The closure subassembly 130 preferably comprises the first closure panel 112 and a second closure panel 127. The base layer of each closure panel 112 and 127 of the closure subassembly is made of CPP and top layer is made of OPP or

RCPP. The breakable polymeric seal is made of EVA.

The closure element 113 is for association with the first closure panel 112, and the closure element 114 is for association with the second closure panel 127. The first closure panel 112 and second closure panel 127 may comprise a non-bonding zone 115 at which the first closure panel and second closure panel are prevented from bonding to each other under an application of heat and pressure. The prevention from bonding may be provided by the strip 117 of material which does not bond under an application of heat and pressure.

The strip 117 is shown in FIG. 19 as associated with the second closure panel 127, but may alternatively be associated with the first closure panel 112, or with each of the first closure panel 112 and second closure panel 127.

The prevention at the non-bonding zone may additionally comprise any of the other suitable preventions, and the strip or strips 117 may be provided as an addition to or integral with either or both of the first closure panel 112 and second closure panel 127.

It may be desirable to provide a closure subassembly 130 in order to simplify the manufacture of a bag 1 according to the invention. The closure subassembly 130 may be provided for bonding to the second primary panel 4 which is the back panel in the form shown in FIG. 19. Alternatively, the first closure panel 112 and second closure panel 127 of the closure subassembly 130 may be bonded together at the header of the closure subassembly 130 prior to the bonding of the closure subassembly to the back panel 4.

FIG. 20 shows the association of a closure subassembly 130 with the back panel 4 of a bag 1. Heat and pressure may be applied to the closure subassembly 130 and the back panel 107 at least at the non-bonding zone 115 to bond the second closure panel 127 to the back panel 4. As shown in FIG. 20, the closure subassembly 130 may also be bonded to the back panel 4 at the header 124, as indicated by the arrows 128.

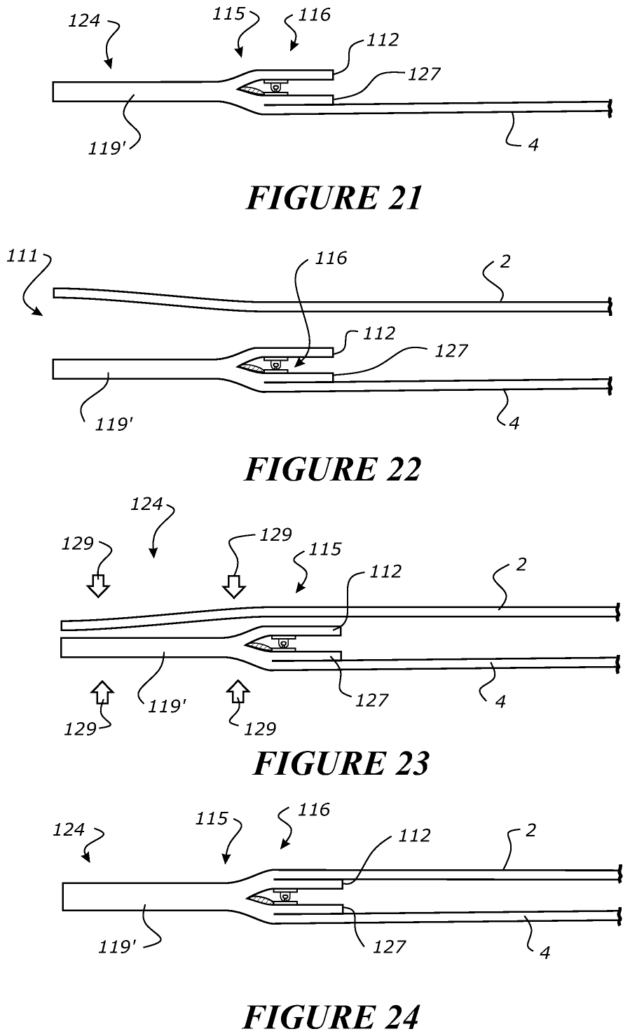

FIG. 21 shows a cross-section of the back panel 4 of a bag 1 which has been bonded with a closure subassembly 130. The second closure panel 127 is bonded to the back panel 4 at the non-bonding zone 115. The closure subassembly 130 comprising the first closure panel 112 and second closure panel 127 is also bonded to the back panel 4 to form a partial header 119′.

The back panel 4 of FIG. 21 may then be joined with the sides and first primary panel 6 of the bag which is the front panel. A cross-section through the resulting bag assembly is shown in FIG. 22. In the configuration of FIG. 22 the first mode opening of the bag 1 is shown at the opening region 111 and past the openable and re-closeable assembly or zip lock 16. The lower compartment 10 of the bag 1 may then be filled with its desired contents.

Once filled, the bag 1 can then be converted to a mode as will be described. The cross-section of FIG. 23 shows the bonding of the combined back panel 4 and closure subassembly 130 to the remainder 122 of the multi-panel assembly and particularly to the front panel 2. Heat and pressure may be applied at least at the non-bonding zone 115, to bond the first closure panel 112 to the front panel 4. The partial header may also be bonded to the front panel 2 at the header zone 124 to form a header 119 of the lower zone 5 of the bag 1.

The resulting lower zone 5 of the bag 1 following the application of heat and pressure along the non-bonding zone and the bonding of the header and front panel 2 at the header zone 124 is shown in FIG. 24. Also shown in FIG. 24 is the bonding of the first closure panel 112 to the front panel 2 at the non-bonding zone 115, and the bonding of the second closure panel 127 to the back panel 4 at the non-bonding zone 115.

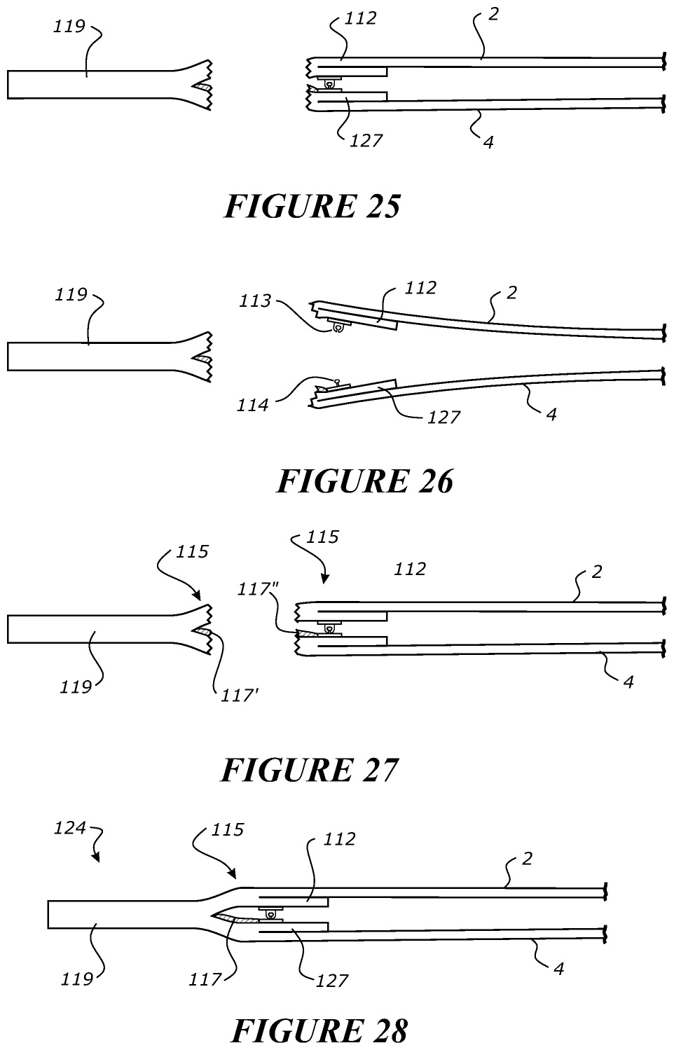

The header 119 may then be removed by a cutting or tearing of the lower zone 5 of bag 1 along the non-bonding zone 115. As shown in FIG. 25, the header 119 has been separated from the remainder of the lower zone 5 of the bag 1 at the non-bonding zone 115. This exposes a mode opening which is able to be defined between the closure element 113 of the first closure panel 112 and the closure element 114 of the second closure panel 127, as shown in FIG. 26.

Bonding of each closure panel 112 and 127 to, respectively, the front panel 2 and back panel 4 at the non-bonding zone 115 allows for a mode opening to be created and for the transfer of the closure element 113 and closure panel 112 from their initial association with the back panel 4 to their mode association with the remainder 122 of the multi-panel assembly, and as shown in FIG. 26.

In a preferred embodiment, the width of each of the first closure panel 112 and the second closure panel towards the base of the bag 1 can just reach the lower edge of the closure elements 113 and 114 (i.e. the edge closer to the base 9), rather than going beyond the said lower edges as shown in for example FIG. 19.

In order to ensure the secure association of each closure panel 112 and 127 with the respective remainder 122 and back panel 112 of the multi-panel assembly of the bag 1, it may be desirable to control the size of the non-bonding zone 115. For example, as shown in FIGS. 27 and 28, the non-bonding zone 115 is wider than shown in relation to previous embodiments.

By the provision of a wider non-bonding zone 115, the first closure panel 112 may be associated with the front panel 2 and the second closure panel 127 may be associated with the back panel 4, over a larger area. This may assist in ensuring the connection of these parts to each other, and potentially providing increased durability to the bag 1. For example, the lower compartment 8 of the bag 1 may be able to undergo an increased number of cycles of opening and closing of the openable and re-closeable closure 116 over its lifetime before failure of the bond between the closure panels and the front and back panels.

A wider non-bonding zone may also make it simpler for a provider who closes the lower compartment of bag 1 after its filling to apply heat and pressure at the header zone 124. This is because a wider non-bonding zone 115 may provide a greater margin of error for the bonding of the header zone 124 without also bonding the closures to each other, meaning that less precision is required in applying the heat and pressure.

If the lower zone 5 of the bag 1 is to be cut or torn at the non-bonding zone 115 to remove a header 119, the location of the cut or tear is preferably more distal the base than the openable and re-closable-closure 116, in order to ensure that each closure panel 112 and 127 remains attached to the remainder 122 and back panel 4 respectively of the lower zone 5 of the bag 1.

From the above description is can be appreciated that a bag 1 may be in a form of a binary pack that is microwaveable to provide a heated food item. The pack may comprise or include (a) the package of the pack, (b) a first microwave heatable food content in a first compartment (e.g. lower compartment 8) of the package, and (c) a second microwave heatable food content in a second compartment (e.g. upper compartment 10) of the package. The package may have a breakthrough zone (zone between upper zone 3 and lower zone 5) that is able, under microwave input to the content(s), to connect the first and second compartments and to allow association of the contents of the first and second compartments. Part of the pack comprising the first compartment can be stabilised within a microwave apparatus with the breakthrough zone and the dependent part of the pack with the second compartment, such that microwave heating of the content of the first compartment is configured to cause the dependent part to rise during and/or subsequent to breakthrough thereby to use gravity to drop at least some of the content of the first compartment onto the content of the second compartment.

The first microwavable food content may be in a liquid or fluid form.

The package may primarily be of front and back panels 2, 4 and that part of the pack with the food compartment may a gusset formation 60 (first gusset formation) or a footing formed by the gusset formation 60 to provide the stability.

The part of pack with the first compartment may have a gusset formation 36 (second gusset formation).

The package may primarily be of a heat sealable plastics film and/or plastics film laminate.

The package may have an openable access or opening (such as opening 20 or mouth entrance 21 opening to allow the heated and moistened food to be consumed.

The package may comprise openable vents (e.g. vent openings 18, 20) that are configured to be opened from a pressure inside the first compartment. The vents may open after breakthrough of the breakthrough zone.

A precursor of the package of the pack may have at least one side closable and/or heat sealable opening to allow one or both the upper and lower compartments to receive content(s). The precursor may have the breakthrough zone already sealed.

In one embodiment, the invention may comprise precursor package stock convertible to be a package of the bag (such as bag 1) in the form of a binary pack.

In one embodiment, invention may comprise a fractioned retail pack (e.g. bag 1) for, all in a microwave apparatus, microwave heating of its contained water fraction and, by breakthrough and gravity association, moistening and heating of its contained food fraction.

In one embodiment the invention may reside in a feedstock of at least primarily plastics film or plastics film laminate to provide the packaging component for a customer usage to prepare a binary pack (e.g. bag 1) being the closed package with a breakthrough zone (zone between upper zone 3 and lower zone 5). There may be food in a first compartment (e.g. lower compartment 8) of the package, and a microwave heatable liquid or liquid product in a second compartment (e.g. upper compartment 10) of the package. There may be an opening of breakthrough zone under microwave input to the binary pack to allow an association of the contents as shown in FIG. 9D. The feedstock may have gusset formation 60 to provide, together with a suitable food, or the food provided with the feedstock, a stable, in microwave apparatus, footing of at least part of the binary pack with at least part of the breakthrough zone above the first compartment.

The invention may also reside in a feedstock to provide a binary microwaveable food pack (e.g. bag 1) of a kind where a microwave heatable item in a first compartment (e.g. upper compartment 10) of the package of the pack, when heated, breaks through a breakthrough zone to a second compartment (e.g. lower compartment 8) of the pack. One of or both of the first and second compartments prior to closure may confine its or their respect content is a bag 1. One of the first and second compartments may define, in conjunction with its content, a stable support base below the breakthrough zone as shown in FIG. 5.

### ABBREVIATIONS AND REMARKS

CPP=cast polypropylene (It is for example heat sealable at about 130 to 150 degrees Celsius, largely depending on the thickness of the CPP material).

PET=polyethylene terephthalate (It is for example non-heat sealable, but can soften at about 200 V degrees Celsius)

PE=polyethylene (It is for example heat sealable at low heat. It can act like cement because it melts at about 110 degrees Celsius)

OPP=oriented polypropylene (It is for example non-heat sealable, but can soften at about 160 degrees Celsius)

EVA=ethylene vinyl acetate (It is for example often used as an easy tearing open film for containers due to its stickiness rather than bonding feature)

RCPP=retortable cast polypropylene (It is for example heat sealable at about 160 to 200 degrees Celsius)

MATT OPP=polytrimethylene terephthalate (It is a matt form of OPP)

PP=polypropylene

Nylon (It is non-heat sealable and can act as a good shield against escape of steam or gas from a container)

It will of course be realised that while the foregoing has been given by way of illustrative example(s) of the present invention, all such modifications and variations thereto as would be apparent to a person skilled in the art are deemed to fall within the broad scope and ambit of the various aspects of invention as is hereinbefore described and/or defined in the claims.

1. A bag for containing at least one item to be heated inside the bag in a microwave oven, the bag comprising:
a first primary panel and a second primary panel, the second primary panel being peripherally formed with and/or heat sealed to the first primary panel to form a containment region within the periphery,
the containment region being split into at least two compartments by at least one seal that is a breakable polymeric seal that is configured to open and be in the open configuration upon heating, the at least one seal extending across the containment region,
the at least two compartments being a lower compartment located proximal to a base of the bag and an upper compartment located above or configured to be located above the lower compartment, the at least two compartments are each being configured to contain the at least one item,
a line of weakness to facilitate tearing, the line of weakness extending across the bag between two opposite sides of the bag along or adjacent the at least one seal, wherein the line of weakness functions as a hinge line so that when the first and second primary panels are close to each other, the hinge line allows drooping of the upper compartment, and when the first and second primary panels move apart, the hinge line allows the upper compartment to be above the lower compartment, and
an openable and re-closable sealing assembly located between the lower compartment and the at least one seal,
wherein the base of the bag is of a gusset formation that is configured to spread open thereby providing footing for stability of the bag when the bag is in a standing position,
wherein, before heating of the at least one item, the at least one seal being configured to be in a closed configuration thereby separating the at least one item in the upper compartment from the at least one item in the lower compartment, and
wherein, during heating of the at least one item, the at least one seal being configured to be in an open configuration so that the at least one item in the upper compartment is adapted to drop into the lower compartment due to gravity and mix with the at least one item in the lower compartment.

2. The bag as claimed in claim 1, wherein the at least one item is a food item.

3. The bag as claimed in claim 1, wherein the upper compartment is configured to contain a liquid item.

4. The bag as claimed in claim 1, wherein the at least two compartments are each being configured to contain different items.

5. The bag as claimed in claim 1, wherein the at least two compartments are each being configured to contain different food items.

6. The bag as claimed in claim 1, wherein the first primary panel is a front panel and a second primary panel is a back panel.

7. The bag as claimed in claim 1, wherein each of the first and second primary panels are made up of a film comprising at least one of the following materials:
Polyethylene terephthalate (PET),
Nylon, and
Retortable cast polypropylene (RCPP).

8. The bag as claimed in claim 1, wherein each of the first and second primary panel is made up of a film comprising three layers, the three layers being a first layer of the film, a second layer of the film and a third layer of the film, the first layer of the film comprising retortable cast polypropylene (RCPP), the second layer of the film comprising Nylon and the third layer of the film comprising Polyethylene terephthalate (PET), wherein the three layers of the film are bonded together.

9. The bag as claimed in claim 8, wherein the first layer of the film is an internal layer facing the containment region, the second layer of the film is an intermediate layer between the first layer of the film and the third layer of the film, and the third layer of the film is an external layer.

10. The bag as claimed in claim 1, wherein the pressure in the containment region causes the bag to be in the standing position.

11. The bag as claimed in claim 1, wherein the breakable polymeric seal comprises ethylene vinyl acetate (EVA).

12. The bag as claimed in claim 1, wherein the breakable polymeric seal comprises at least two layers, the two layers being a first layer of the breakable polymeric seal and a second layer of the breakable polymeric seal, the first layer of the breakable polymeric seal comprising ethylene vinyl acetate (EVA) and the second layer of the breakable polymeric seal comprising cast polypropylene (CPP), wherein the two layers of the breakable polymeric seal are bonded together.

13. The bag as claimed in claim 12, wherein the breakable polymeric seal is configured to be bonded with a closure subassembly, the closure subassembly comprising two layers, the two layers being a first layer of the closure subassembly and a second layer of the closure subassembly, the first layer of the closure subassembly being oriented polypropylene (OPP) or retortable cast polypropylene (RCPP) and the second layer of the closure subassembly being cast polypropylene (CPP).

14. The bag as claimed in claim 13, wherein the first layer of the breakable polymeric seal is configured to be bonded with the first layer of the closure subassembly.

15. The bag as claimed in claim 1, wherein the breakable polymeric seal is bonded to or formed as a part of the first primary panel and the closure subassembly is bonded to or formed as the part of the second primary panel.

16. The bag as claimed in claim 1, wherein the breakable polymeric seal is bonded to or formed as a part of the second primary panel and the closure subassembly may be bonded to or formed as the part of the first primary panel.

17. The bag as claimed in claim 1, wherein the openable and re-closable sealing assembly is a zip lock.

18. The bag as claimed in claim 17, wherein the zip lock is made out of polypropylene (PP) or polyethylene (PE).

19. The bag as claimed in claim 1, wherein the bag further comprises an opening at or near a top portion of the bag which is opposite the base of the bag, the at least one item is configured to enter the upper compartment of the bag through the opening.

20. The bag as claimed in claim 19, wherein the opening comprises an upper openable and re-closable assembly which when opened allows access to the upper compartment through the opening and which when closed prevents access to the upper compartment though the opening.

21. The bag as claimed in claim 20, wherein the upper openable and re-closable assembly is an upper zip lock.

22. The bag as claimed in claim 21, wherein the upper zip lock is made out of polypropylene (PP) or polyethylene (PE).

23. The bag as claimed in claim 1, wherein the bag further comprises a non-heat sealable assembly comprising a first non-heat sealable layer and a second non-heat sealable layer, the first and second non-heat sealable layers extending across the bag between two opposite sides of the bag and facing each other, the non-heat sealable assembly being located above the openable and re-closable assembly.

24. The bag as claimed in claim 23, wherein at least one of the first or second non-heat sealable layer comprises at least one of the following materials:
Polyethylene (PE),
Polypropylene (PP),
Polyethylene terephthalate (PET), and
Cast polypropylene (CPP).

25. The bag as claimed in claim 23, wherein the first non-heat sealable layer is made up of a film that comprises two layers, the two layers being a first layer of the film of the first non-heat sealable layer and a second layer of the film of the first non-heat sealable layer, the first layer of film of the first non-heat sealable layer comprising polyethylene terephthalate (PET) and the second layer of film comprising polyethylene terephthalate (CPP), wherein the two layers are bonded together.

26. The bag as claimed in claim 23, wherein the second non-heat sealable layer is made up of a film that comprises two layers, the two layers being a first layer of the film of the second non-heat sealable layer and a second layer of the film of the second non-heat sealable layer, the first layer of the film of the second non-heat sealable layer comprising polyethylene (PE) or polypropylene (PP) and the second layer of the film of the second non-heat sealable layer comprising cast polypropylene (CPP), wherein the two layers of the film of the second non-heat sealable layer are bonded together.

27. The bag as claimed in claim 1, wherein a tear notch is provided at one or each of the opposite sides of the bag at where the bag can be torn by a user.

28. The bag as claimed in claim 1, wherein the bag further comprises a vent opening that is provided at one or each opposite sides of the bag at an upper zone where the upper compartment is located, the vent opening being configured to open during heating of the at least one item to allow gas and/or steam to escape the containment region.

29. The bag as claimed in claim 28, wherein the upper zone comprises an upper gusset formation that is configured to spread open due to pressure in the containment region.

30. The bag as claimed in claim 28, wherein the upper zone comprises a vent layer or vent tape extending across the bag along a fold line of the upper gusset formation, the vent layer vent tape being configured to provide the vent openings.

31. The bag as claimed in claim 30, wherein the vent layer or vent tape comprises ethylene vinyl acetate (EVA).

32. The bag as claimed in claim 30, wherein the vent layer or vent tape comprises at least two layers, the two layers being a first layer of the vent layer or first layer of the vent tape and a second layer of the vent layer or second layer of the vent tape, the first layer of the vent layer or the first layer of the vent tape comprising ethylene vinyl acetate (EVA) and the second layer of the vent layer or the second layer of the vent tape comprising polyethylene terephthalate (PET), wherein the two layers of the vent layer or two layers of the vent tape are bonded together.

33. A bag for heating or cooking by heating at least one food item in a microwave oven, the bag comprising:
a first primary panel and a second primary panel peripherally formed with and/or sealed to the first primary panel to form a containment region within the periphery, the bag being split into at least two zones by a breakable polymeric seal across the containment region to create a lower zone at a base of the bag and an upper zone located or configured to be located above the lower zone, the breakable polymeric seal being adapted to break and be in an open configuration when the containment region is heated thereby causing the at least food item in the containment region of the upper zone to move to the lower zone and mix with the at least one food item in the containment region of the lower zone,
a line of weakness to facilitate tearing, the line of weakness extending across the bag between two opposite sides of the bag along or adjacent the breakable polymeric seal, the line of weakness functions as a hinge line so that when the first and second primary panels are close to each other, the hinge line allows drooping of the upper zone, and when the first and second primary panels move apart, the hinge line allows the upper zone to be above the lower zone, and
an openable and re-closable sealing assembly located between a lower compartment of the lower zone and the breakable polymeric seal,
wherein the base of the bag is of a gusset formation that is configured to spread open thereby providing footing for stability of the bag when the bag is in a standing position.

34. The bag as claimed in claim 33, wherein the upper zone comprises an upper compartment and the lower zone comprises the lower compartment, the upper and lower compartments being configured to store the at least one food item.

35. The bag as claimed in claim 33, wherein the first primary panel is a front panel and the second primary panel is a back panel.

36. The bag as claimed in claim 33, wherein the breakable polymeric seal in made out of ethylene vinyl acetate (EVA).

37. The bag as claimed in claim 33, wherein the breakable polymeric seal comprises at least two layers, the two layers being a first layer of the breakable polymeric seal and a second layer of the breakable polymeric seal, the first layer of the breakable polymeric seal comprising ethylene vinyl acetate (EVA) and the second layer of the breakable polymeric seal comprising cast polypropylene (CPP), wherein the two layers are bonded together.

38. The bag as claimed in claim 37, wherein the breakable polymeric seal is configured to be bonded with a closure subassembly, the closure subassembly comprising two layers, the two layers being a first layer of the closure subassembly and a second layer of the closure subassembly, the first layer of the closure subassembly being oriented polypropylene (OPP) or retortable cast polypropylene (RCPP) and the second layer of the closure subassembly being cast polypropylene (CPP).

39. The bag as claimed in claim 38, wherein the first layer of the breakable polymeric seal is configured to be bonded with the first layer of the closure subassembly.

40. The bag as claimed in claim 33, wherein the breakable polymeric seal is bonded to or formed as a part of the first primary panel and the closure subassembly layer may be bonded to or formed as the part of the second primary panel.

41. The bag as claimed in claim 33, the breakable polymeric seal may be bonded to or formed as a part of the second primary panel and the closure subassembly layer may be bonded to or formed as the part of the first primary panel.

42. The bag as claimed in claim 33, wherein each of the first and second primary panels are made up of a film comprising at least one of the following materials:
Polyethylene terephthalate (PET),
Nylon, and
Retortable cast polypropylene (RCPP).

43. The bag as claimed in claim 33, wherein each of the first and second primary panels are made up of a film comprising three layers, the three layers being a first layer of the film, a second layer of the film and a third layer of the film, the first layer of the film comprising Retortable cast polypropylene (RCPP), the second layer comprising Nylon and the third layer comprising polyethylene terephthalate (PET), wherein the three layers of the film are bonded together.

44. The bag as claimed in claim 43, wherein the first layer of the film is an internal layer facing the containment region, the second layer of the film is an intermediate layer between the first layer of the film and the third layer of the film, and the third layer of the film is an external layer.

45. The bag as claimed in claim 33, wherein the pressure in the containment region causes the bag to be in the standing position.

46. The bag as claimed in claim 33, wherein the openable and re-closable sealing assembly is a zip lock.

47. The bag as claimed in claim 46, wherein the zip lock is made out of polypropylene (PP) or polyethylene (PE).

48. The bag as claimed in claim 34, wherein the bag further comprises an opening at or near a top portion of the bag which is opposite the base of the bag, the at least one food item is configured to enter the upper zone of the bag through the opening.

49. The bag as claimed in claim 48, wherein the opening comprises an upper openable and re-closable assembly which when opened allows access to the upper compartment through the opening and which when closed prevents access to the upper compartment though the opening.

50. The bag as claimed in claim 49, wherein the upper openable and re-closeable assembly is an upper zip lock.

51. The bag as claimed in claim 50, wherein the upper zip lock is made out of polypropylene (PP) or polyethylene (PE).

52. The bag as claimed in claim 33, wherein the bag further comprises a non-heat sealable assembly comprising a first non-heat sealable layer and a second non-heat sealable layer, the first and second non-heat sealable layers extending across the bag between two opposite sides of the bag and facing each other, the non-heat sealable assembly being located above the openable and re-closable assembly.

53. The bag as claimed in claim 52, wherein at least one of the first or second non-heat sealable layers comprises at least one of the following materials:
polyethylene (PE),
polypropylene (PP),
polyethylene terephthalate (PET), and
cast polypropylene (CPP).

54. The A bag as claimed in claim 52, wherein the first non-heat sealable layer is made up of a film that comprises two layers, the two layers being a first layer of the film of the first non-heat sealable layer and a second layer of the film of the first non-heat sealable layer, the first layer of the film of the first non-heat sealable layer comprising polyethylene terephthalate (PET) and the second layer of the film of the first non-heat sealable layer comprising cast polypropylene (CPP), wherein the two layers of the film of the first non-heat sealable layer are bonded together.

55. The bag as claimed in claim 52, wherein the second non-heat sealable layer is made up of a film that comprises two layers, the two layers being a first layer of the film of the second non-heat sealable layer and a second layer of the film of the second non-heat sealable layer, the first layer of the film of the second non-heat sealable layer comprising PE or PP and the second layer of the film of the second non-heat sealable layer comprising CPP, wherein the two layers of the film of the second non-heat sealable layer are bonded together.

56. The bag as claimed in claim 33, wherein a tear notch is provided at one or each of the opposite sides of the bag at where the bag can be torn by a user.

57. The bag as claimed in claim 34, wherein the bag further comprises a vent opening that is provided at one or each opposite sides of the bag at an upper zone where the upper compartment is located, the vent opening being configured to open during heating of the at least one food item to allow at least one of the gas or steam to escape the containment region.

58. The bag as claimed in claim 34, wherein the upper zone comprises a gusset formation or an upper gusset formation that is configured to spread open due to pressure in the containment region.

59. The bag as claimed in claim 58, wherein the upper zone comprises a vent layer (vent tape) extending across the bag along a fold line of the gusset formation or the upper gusset formation, the vent layer or vent tape being configured to provide the vent openings.

60. The bag as claimed in claim 59, wherein the vent layer or vent tape comprises ethylene vinyl acetate (EVA).

61. The bag as claimed in claim 59, wherein the vent layer or vent tape comprises at least two layers of the vent layer or the vent tape, the two layers of the vent layer or the vent tape being a first layer of the vent layer or a first layer of the vent tape and a second layer of the vent layer or a second layer of the vent tape, the first layer of the vent layer or the first layer of the vent tape comprising ethylene vinyl acetate (EVA) and the second layer of vent layer or the second layer of the vent tape comprising polyethylene terephthalate (PET), wherein the two layers of the vent layer or the vent tape are bonded together.

62. A method of using the bag as claimed in claim 1, wherein the method comprises at least the following steps:
providing the bag;
introducing at least one item or food into the bag so that the upper and lower compartments are both filled with the at least one item or food;
sealing or closing any openings so that there is no leakage of the at least one item or food from the containment region and so that the at least one item or food in the upper compartment can be separated from the at least one item or food in the lower compartment at least until a pre-heating stage; and
providing the bag useable to an end user.

63. A method of manufacture of a bag for heating at least one item of commerce, the method comprising:
providing as a bag for heating the at least one item comprising a first primary panel and a second primary panel peripherally formed with and/or sealed to the first primary panel to form a containment region within the periphery, the bag being split into at least two zones by at least one seal that is a breakable polymeric seal that is configured to open and be in the open configuration upon heating, the at least one seal extending across the containment region to create a lower zone at a base of the bag and an upper zone located or configured to be located above the lower zone, wherein the at least one seal is configured to allow any item in the upper zone to move and mix with any item in the lower zone when heated, the bag comprising a line of weakness to facilitate tearing, the line of weakness extending across the bag between two opposite sides of the bag along or adjacent the at least one seal, the line of weakness functions as a hinge line so that when the first and second primary panels are close to each other, the hinge line allows drooping of the upper zone, and when the first and second primary panels move apart, the hinge line allows the upper zone to be above the lower zone, the bag further comprising an openable and re-closable sealing assembly located between a lower compartment of the lower zone and the at least one seal, wherein the base of the bag is of a gusset formation that is configured to spread open thereby providing footing for stability of the bag when the bag is in a standing position;
introducing the at least one item into the containment region so that the at least one item is located in one or both of the upper and lower zones; and
closing any opening of the bag by an application of heat and pressure so that there is no leakage of item(s) from the containment region and so that the at least one item in the upper compartment can be separated from the at least one item in the lower compartment at least until a pre-heating stage.

64-131. (canceled)
